(19) United States
(12) Patent Application Publication
(10) Pub. No.: US 2024/0022563 A1
(43) Pub. Date: Jan. 18, 2024

(54) SERVER DEVICE, SYSTEM, SERVER DEVICE CONTROLLING METHOD, AND STORAGE MEDIUM

(71) Applicant: NEC Corporation, Minato-ku, Tokyo (JP)

(72) Inventors: Masanori KOBAYASHI, Tokyo (JP); Akihiko Ichikawa, Tokyo (JP); Shinya Masuda, Tokyo (JP)

(73) Assignee: NEC Corporation, Minato-ku, Tokyo (JP)

(21) Appl. No.: 18/036,863

(22) PCT Filed: Nov. 24, 2020
(86) PCT No.: PCT/JP2020/043535

§ 371 Date: May 12, 2023

(51) Int. Cl. H04L 9/40

(52) U.S. Cl. CPC H04L 63/0861

(57) ABSTRACT

A server device according to the present disclosure includes: at least one memory storing a set of instructions; and at least one processor configured to execute the set of instructions to: acquire, of each of a plurality of users, biometric information and a test result of a test necessary for quarantine; and receive an authentication request including biometric information about an authenticatee from a gate device; identify the authenticatee from among the plurality of users using biometric information about each of the plurality of users and biometric information about the authenticatee; and transmit an authentication result determined based on the test result of at least the identified authenticatee to the gate device.

### TECHNICAL FIELD

The present invention relates to a server device, a system, a server device controlling method, and a storage medium.

### BACKGROUND ART

Services using biometric authentication have started to spread. For example, PTL 1 describes providing an immigration inspection system that can easily use an automated gate.

PTL 1 describes the following various means. The receiving means receives the expected entry information including a personal ID of the expected entrant. The biometric information acquisition means acquires the stored biometric information about the expected entrant based on the personal ID. A blacklist collation means collates an entrant with blacklist information based on a personal ID of the entrant. The biometric information reading means reads the biometric information about the expected entrant from the expected entrant. The biometric matching means collates the received biometric information with the read biometric information. In a case where the gate has successfully collated the biometric information and the biometric information does not correspond to the blacklist information, the entry of the expected entrant is permitted.

### CITATION LIST

### Patent Literature

PTL 1: JP 2015-222459 A

### SUMMARY OF INVENTION

### Technical Problem

In the period of spread of infectious diseases and the like, it is necessary to perform quarantine for entrants from abroad (confirmation that the entrants do not suffer from infectious diseases). When the number of entrants to be tested is enormous, it is required to efficiently perform the above-described quarantine. This is because when the quarantine is not performed efficiently, a large number of passengers will stay in the airport, the convenience of the user is reduced, and the stay causes a new infection. In this regard, PTL 1 merely discloses that biometric authentication is applied to the entry procedure, and the above problem cannot be solved.

A main object of the present invention is to provide a server device, a system, a server device controlling method, and a storage medium that contribute to efficient quarantine against infectious diseases and the like.

### Solution to Problem

According to a first aspect of the present invention, there is provided a server device including an acquisition unit that acquires, of each of a plurality of users, biometric information and a test result of a test necessary for quarantine, and an authentication request processing unit that receives an authentication request including biometric information about an authenticatee from a gate device, identifies the authenticatee from among the plurality of users using biometric information about each of the plurality of users and biometric information about the authenticatee, and transmits an authentication result determined based on the test result of at least the identified authenticatee to the gate device.

According to a second aspect of the present invention, there is provided a system including a gate device that controls a gate, and a server device connected to the gate device, wherein the server device includes an acquisition unit that acquires, of each of a plurality of users, biometric information and a test result of a test necessary for quarantine, and an authentication request processing unit that receives an authentication request including biometric information about an authenticatee from the gate device, identifies the authenticatee from among the plurality of users using biometric information about each of the plurality of users and biometric information about the authenticatee, and transmits an authentication result determined based on the test result of at least the identified authenticatee to the gate device.

According to a third aspect of the present invention, there is provided a server device controlling method, the method executed by a server device including the server device acquiring, of each of a plurality of users, biometric information and a test result of a test necessary for quarantine, receiving an authentication request including biometric information about an authenticatee from a gate device, identifying the authenticatee from among the plurality of users using biometric information about each of the plurality of users and biometric information about the authenticatee, and transmitting an authentication result determined based on the test result of at least the identified authenticatee to the gate device.

According to a fourth aspect of the present invention, there is provided a computer-readable storage medium storing a program for causing a computer mounted on a server device to execute the steps of acquiring, of each of a plurality of users, biometric information and a test result of a test necessary for quarantine, receiving an authentication request including biometric information about an authenticatee from a gate device, identifying the authenticatee from among the plurality of users using biometric information about each of the plurality of users and biometric information about the authenticatee, and transmitting an authentication result determined based on the test result of at least the identified authenticatee to the gate device.

### Advantageous Effects of Invention

According to each aspect of the present invention, there are provided a server device, a system, a server device controlling method, and a storage medium that contribute to efficient quarantine against infectious diseases and the like. The effect of the present invention is not limited to the above. According to the present invention, other effects may be exhibited instead of or in addition to the effect.

### BRIEF DESCRIPTION OF DRAWINGS

FIG. 1 is a diagram for describing an outline of an example embodiment.

FIG. 2 is a diagram illustrating an example of a schematic configuration of a quarantine system according to the first example embodiment.

FIG. 3 is a diagram for explaining an operation of the quarantine system according to the first example embodiment.

FIG. 4 is a diagram for explaining an operation of the quarantine system according to the first example embodiment.

FIG. 5 is a diagram for explaining an operation of the quarantine system according to the first example embodiment.

FIG. 6 is a diagram for explaining an operation of the quarantine system according to the first example embodiment.

FIG. 7 is a diagram for explaining an operation of the quarantine system according to the first example embodiment.

FIG. 8 is a diagram for explaining an operation of the quarantine system according to the first example embodiment.

FIG. 9 is a diagram for explaining an operation of the quarantine system according to the first example embodiment.

FIG. 10 is a diagram for explaining an operation of the quarantine system according to the first example embodiment.

FIG. 11 is a diagram for explaining an operation of the quarantine system according to the first example embodiment.

FIG. 12 is a diagram for explaining an operation of the quarantine system according to the first example embodiment.

FIG. 13 is a diagram illustrating an example of a processing configuration of a reception terminal according to the first example embodiment.

FIG. 14 is a diagram illustrating an example of a processing configuration of a terminal according to the first example embodiment.

FIG. 15 is a diagram illustrating an example of a processing configuration of a quarantine terminal according to the first example embodiment.

FIG. 16 is a diagram illustrating an example of a processing configuration of a gate device according to the first example embodiment.

FIG. 17 is a diagram illustrating an example of a processing configuration of a server device according to the first example embodiment.

FIG. 18 is a diagram illustrating an example of a passenger information database according to the first example embodiment.

FIG. 19 is a sequence diagram illustrating an example of an operation of the quarantine system according to the first example embodiment.

FIG. 20 is a sequence diagram illustrating an example of an operation of the quarantine system according to the first example embodiment.

FIG. 21 is a sequence diagram illustrating an example of an operation of the quarantine system according to the first example embodiment.

FIG. 22 is a sequence diagram illustrating an example of an operation of the quarantine system according to the first example embodiment.

FIG. 23 is a sequence diagram illustrating an example of an operation of the quarantine system according to the first example embodiment.

FIG. 24 is a diagram illustrating an example of a hardware configuration of the server device of the present disclosure.

FIG. 25 is a sequence diagram illustrating an example of an operation of a quarantine system according to a modification of the present disclosure.

FIG. 26 is a diagram illustrating an example of a schematic configuration of a quarantine system according to a modification of the present disclosure.

### EXAMPLE EMBODIMENT

First, an outline of an example embodiment will be described. The reference numerals in the drawings attached to this outline are attached to each of elements for convenience as an example for assisting understanding, and the description of this outline is not intended to be any limitation. Unless there is a specific reason to the contrary, the block described in each drawing represents not a configuration of a hardware unit but a configuration of a functional unit. Connection lines between blocks in each drawing include both bidirectional and unidirectional lines. The unidirectional arrow schematically indicates a flow of a main signal (data), and does not exclude bidirectionality. In the present specification and the drawings, elements that can be similarly described are denoted by the same reference numerals, and redundant description can be omitted.

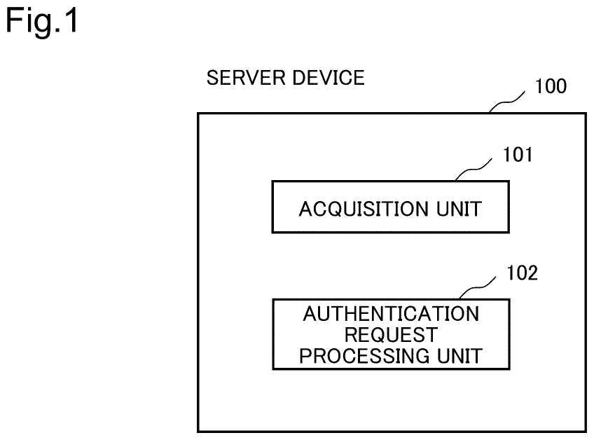

A server device 100 according to an example embodiment includes an acquisition unit 101 and an authentication request processing unit 102 (see FIG. 1). The acquisition unit 101 acquires, for each of the plurality of users, biometric information and the test result of a test necessary for the quarantine. The authentication request processing unit 102 receives, from a gate device, an authentication request including biometric information about an authenticatee, and identifies the authenticatee from among the plurality of users using the biometric information about each of the plurality of users and the biometric information about the authenticatee. The authentication request processing unit 102 transmits, to the gate device, the authentication result determined based on the test result of the at least identified authenticatee.

The server device 100 acquires and stores biometric information about a user (airport user, passenger) and a test result regarding the user (test result necessary for the quarantine operation). The server device 100 receives the authentication request of the user from the gate device installed in the quarantine station. When processing the authentication request, the server device 100 determines an authentication result (permit and refuse to pass through gate device) based on a test result of the authenticatee. That is, the user cannot pass through the gate device unless the test result has no problem and the quarantine has been normally completed. The quarantine officer or the like does not need to notify the user who has completed the test of the completion of the quarantine or the like, and can concentrate on the quarantine (test) operation. As a result, quarantine against infectious diseases and the like is efficiently performed.

Hereinafter, specific example embodiments will be described in more detail with reference to the drawings.

### First Example Embodiment

The first example embodiment will be described in more detail with reference to the drawings.

### [Configuration of System]

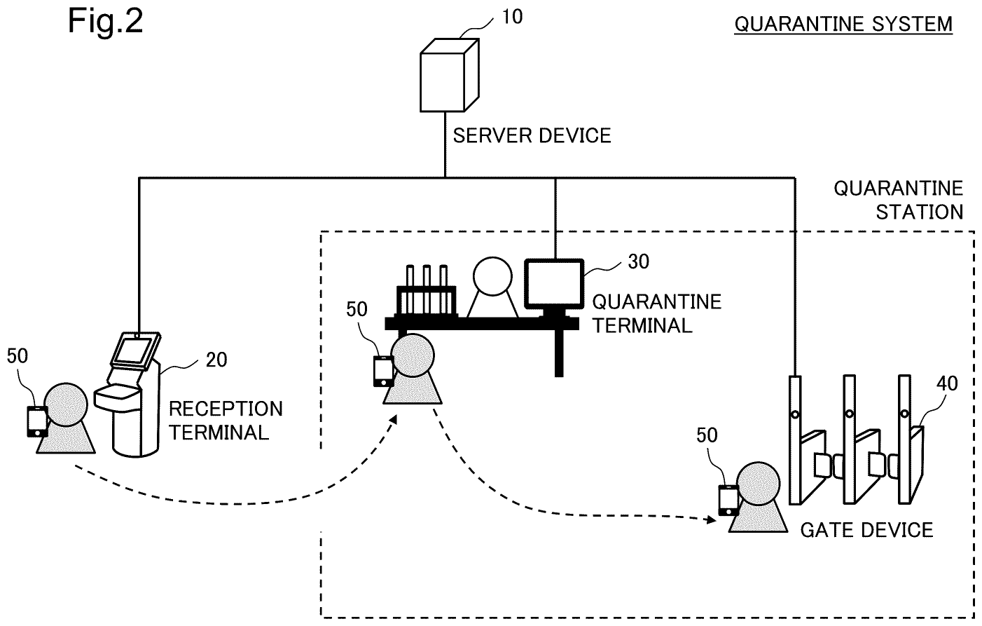

FIG. 2 is a diagram illustrating an example of a schematic configuration of the quarantine system according to the first example embodiment. A quarantine system according to a first example embodiment is a system that quarantines passengers and the like at an airport. The quarantine system illustrated in FIG. 2 is operated by, for example, a public institution such as a control station for immigration or emigration, or a trustee who has received a commission from the public institution.

In the first example embodiment, a case where the quarantine is performed on an entrant from a foreign country at an airport will be described, but it is not intended to limit a place or an opportunity for performing the quarantine. For example, the quarantine may be performed at the time of departure, or the quarantine may be performed at the port. Alternatively, the quarantine of the present disclosure may be performed by a medical institution such as a test center or a hospital. That is, the quarantine method of the present disclosure may be executed at a place other than the airport.

In the quarantine system illustrated in FIG. 2, a passenger (user) is identified by biometric authentication, and a result of the quarantine test is managed together with biometric information about the passenger. In the figures including FIG. 2, a person in grey indicate a passenger and a person in white indicate a quarantine officer.

Examples of the biometric information about the passenger include data (feature value) calculated from physical characteristics unique to an individual such as a face, a fingerprint, a voiceprint, a pattern (pattern) of an iris of a vein, a retina, and a pupil. Alternatively, the biometric information may be image data such as a face image and a fingerprint image. The biometric information may include physical characteristics of the resident as information. In the first example embodiment, a case will be described in which biometric information (a face image or a feature value generated from the face image) regarding a “face” of a person is used.

Referring to FIG. 2, the quarantine system includes a server device 10, a reception terminal 20, a quarantine terminal 30, and a gate device 40.

The server device 10 is a device that controls the entire quarantine system. The server device 10 is installed in an airport. Alternatively, the server device 10 may be a server installed in a cloud on a network.

The reception terminal 20 is a terminal (so-called kiosk terminal) installed at an airport. The passenger prepares for being quarantined by biometric authentication at the reception terminal 20. More specifically, the passenger performs system registration for receiving a quarantine procedure by biometric authentication using the reception terminal 20.

The quarantine terminal 30 and the gate device 40 are installed in a quarantine station. The quarantine station is located at an airport terminal. Passengers who get off the airplane are tested on whether they suffer from an infectious disease at a quarantine station. A passenger confirmed not to suffer from an infectious disease and having a low possibility of suffering from an infectious disease can proceed to the subsequent procedure (immigration office, customs office).

The quarantine officer operates the quarantine terminal 30 to perform the quarantine operation. The quarantine officer inputs information related to a person to be quarantined (a passenger who undergoes a quarantine test) using the quarantine terminal 30.

The gate device 40 is installed at an exit of a quarantine station. The gate device 40 permits passage of a passenger whose quarantine has been terminated normally.

The passenger carries a terminal 50. The terminal 50 is a mobile terminal such as a mobile phone or a smartphone.

The devices illustrated in FIG. 2 are connected via a network. The network includes a local area network (LAN) including an airport local communication network, a wide area network (WAN), a mobile communication network, and the like. The connection method is not limited to the wired method, and may be a wireless method.

The configuration illustrated in FIG. 2 is an example and is not intended to limit the configuration of the quarantine system. The quarantine system may include a terminal (not illustrated) or the like. For example, a digital signage or the like that provides information to passengers may be included in the system. For example, the digital signage may notify the passenger that system registration is necessary in the reception terminal 20 in order to receive a quarantine procedure by biometric authentication, or may display items required for the passenger in the quarantine station.

### [Schematic Operation of System]

Next, an outline of an operation of the quarantine system will be described with reference to the drawings.

First, the passenger makes preparations (system registration) for receiving a quarantine procedure by biometric authentication at the reception terminal 20. The reception terminal 20 reads information about the passport possessed by the passenger. Further, the reception terminal 20 acquires biometric information (for example, a face image) of the passenger.

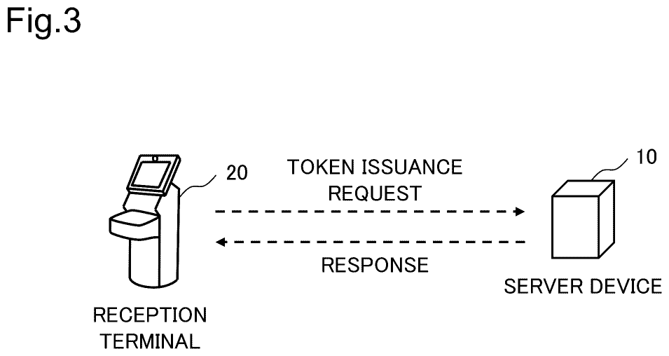

Reception terminal 20 transmits the “token issuance request” including the information about the passport and the biometric information to server device 10 (see FIG. 3).

The server device 10 checks identification of the passenger using the information acquired from the reception terminal 20. When the identification is successfully confirmed, the server device 10 issues a token used for a quarantine procedure of the passengers. When the token is issued, the server device 10 adds a new entry to the passenger information database for managing the passenger. Details of the passenger information database will be described later.

The issued token is identified by a token identifier (ID). Information (for example, biometric information, test results, and the like) necessary for the quarantine procedure is managed using the token ID. That is, the “token” is identification information for the passenger to receive a quarantine procedure using the biometric information.

The server device 10 that has processed the token issuance request transmits a response to the token issuance request to the reception terminal 20. When the token is normally issued, the server device 10 transmits an acknowledgment to the reception terminal 20. When failing to issue the token, the server device 10 transmits a negative acknowledgment to the reception terminal 20.

When receiving the acknowledgment (token issuance completion), the reception terminal 20 provides the passenger with the application. The application provided by the reception terminal 20 is an application that assists the passenger to perform the quarantine procedure. For example, the passenger inputs information about his/her health and identification information about the test kit to the system using the application. Hereinafter, the application provided to the passengers by the reception terminal 20 is referred to as a “quarantine application”.

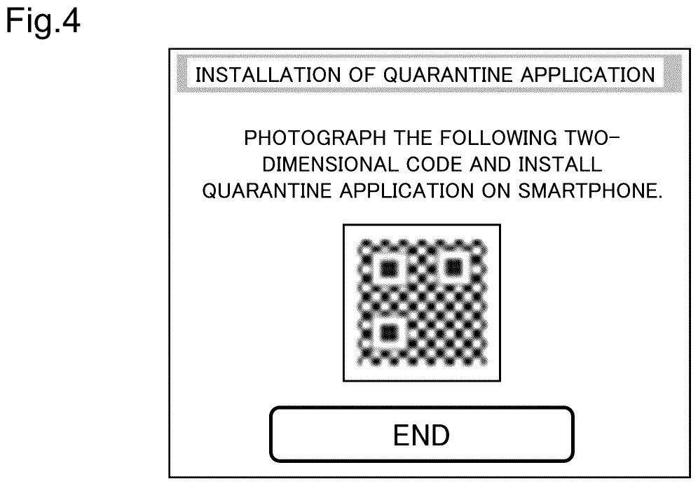

For example, the reception terminal 20 displays a graphical user interface (GUI) describing a two-dimensional code for downloading the quarantine application (see FIG. 4). The passenger operates the terminal 50 possessed by the passenger to access the server indicated by the two-dimensional code and download the quarantine application. The terminal 50 installs the downloaded quarantine application.

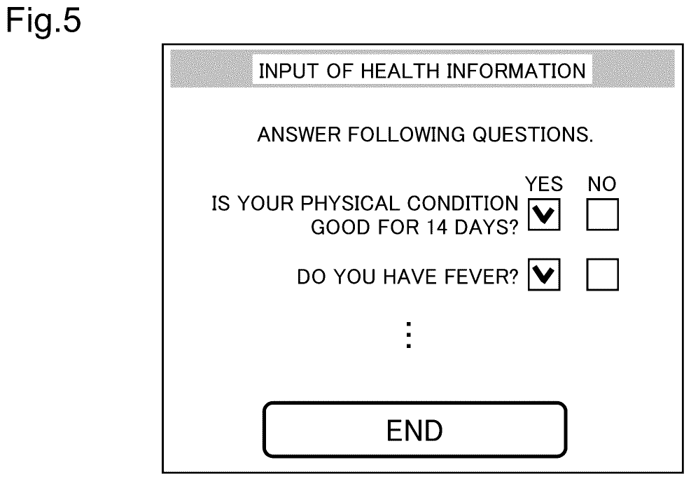

The passenger activates the quarantine application. When the quarantine application is activated, the terminal 50 asks a question about the health of the passenger (see FIG. 5). The terminal 50 acquires the answer of the passenger. The terminal 50 acquires biometric information (for example, a face image) of the passenger. For example, the terminal 50 acquires the biometric information about the passenger at the timing when the passenger presses the “END” button illustrated in FIG. 5.

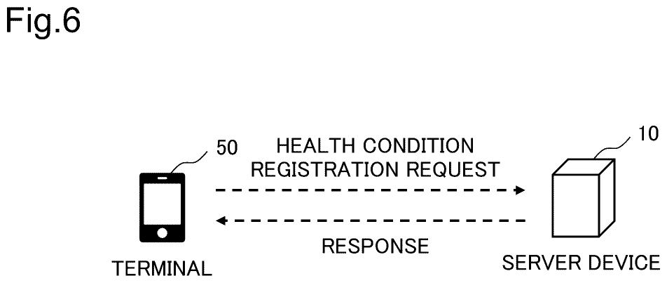

The terminal 50 transmits a “health condition registration request” including the acquired answer (the answer to the question about health; information about health) and biometric information to the server device 10 (see FIG. 6). In the following description, an answer to a question about health will be referred to as “health information”.

The server device 10 determines the health condition of the passenger based on the health information (answer to the question) included in the health condition registration request. The server device 10 identifies the passenger by the collation process using the acquired biometric information, and stores the determined health condition (good, bad) in the passenger information database. The server device 10 that has processed the health condition registration request transmits a response to the request to the terminal 50. When the health condition is normally registered, the server device 10 transmits an acknowledgment to the terminal 50. When the registration of the health condition fails, the server device 10 transmits a negative acknowledgment to the terminal 50.

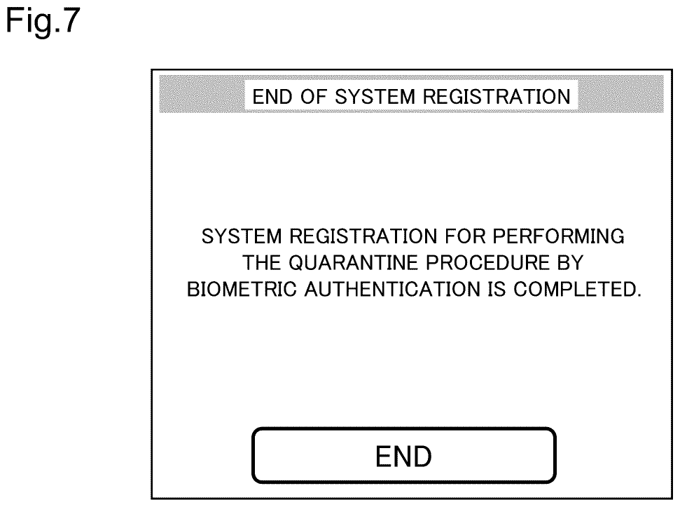

The terminal 50 that has received the acknowledgment notifies the passenger that the system registration is completed. For example, the terminal 50 performs a display as illustrated in FIG. 7 and displays that a quarantine procedure can be performed by biometric authentication.

The description returns to FIG. 2. Once the system registration is completed, the passengers head to the quarantine station. The passengers enter a quarantine station and move to a booth where a quarantine officer waits. The passenger receives a test kit from the quarantine officer. A test kit ID for identifying the kit is given to the test kit. For example, the test ID kit ID is attached to the test kit in the form of a barcode or a two-dimensional code.

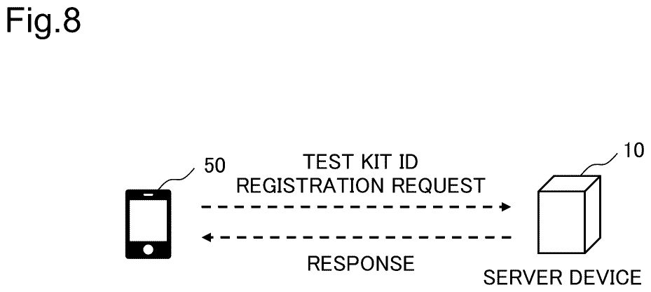

When the test kit is received, the passenger operates the terminal 50 to activate the quarantine application. The passenger reads the test kit ID given to the test kit using the activated quarantine application. The terminal 50 transmits a “test kit ID registration request” including the biometric information (face image) of the passenger and the test kit ID to the server device 10 (see FIG. 8).

The biometric information included in the test kit ID registration request may be biometric information previously acquired at the time of system registration, or may be biometric information acquired at the time of reading the test kit ID. From the viewpoint of fraud prevention, it is desirable that biometric information acquired when the test kit ID is read be transmitted to the server device 10.

The server device 10 identifies the passenger from the acquired biometric information, and stores the test kit ID in the passenger information database. The server device 10 that has processed the test kit ID registration request transmits a response to the request to the terminal 50. When the test kit ID is normally registered, the server device 10 transmits an acknowledgment to the terminal 50. When the registration of the test kit ID fails, the server device 10 transmits a negative acknowledgment to the terminal 50.

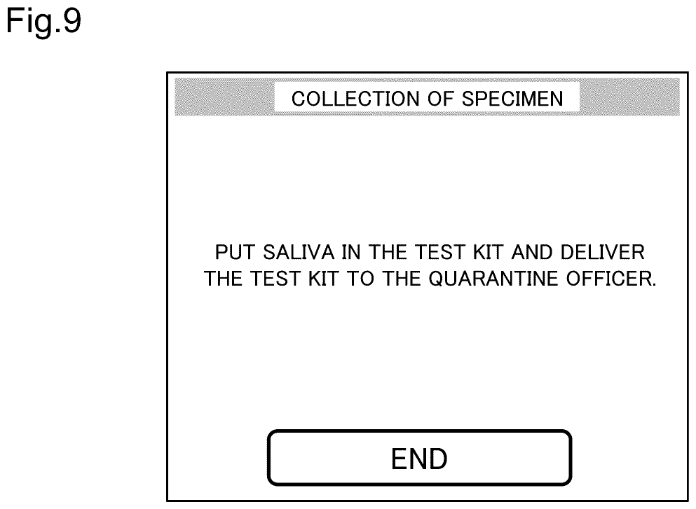

The terminal 50 that has received the acknowledgment prompts the passenger to collect the specimen. For example, the terminal 50 prompts the passenger to collect a specimen by a display as illustrated in FIG. 9. In the present disclosure, any test method or test means (test kit) can be used. For example, a test method such as a polymerase chain reaction (PCR) test, an antibody test, or an antigen test can be used, and a test kit for handling saliva or blood can be used.

The passenger collects the specimen according to the display of the terminal 50 (display of the quarantine application). The passenger delivers the test kit storing the specimen to the quarantine officer. The quarantine officer conducts a test using the collected specimen (test as to whether the passenger suffers from an infectious disease).

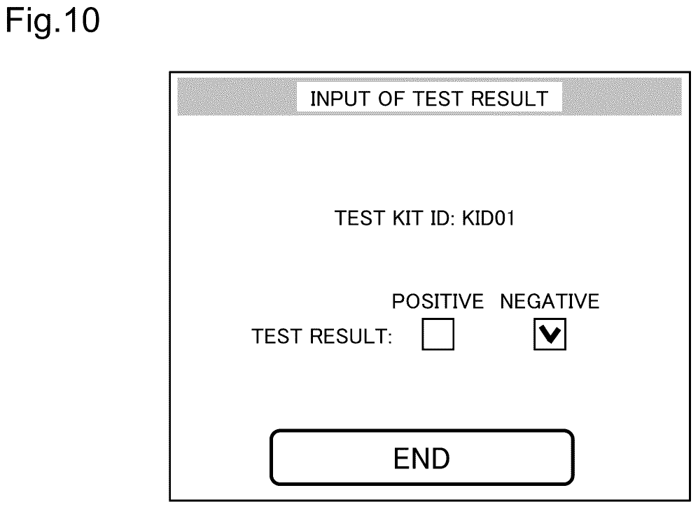

The quarantine officer registers the test result (positive, negative) in the server device 10. For example, the quarantine officer reads the test kit ID of the test kit whose result is known using a barcode reader or the like connected to the quarantine terminal 30. When reading the test kit ID, the quarantine terminal 30 displays a GUI as illustrated in FIG. 10 and acquires a test result.

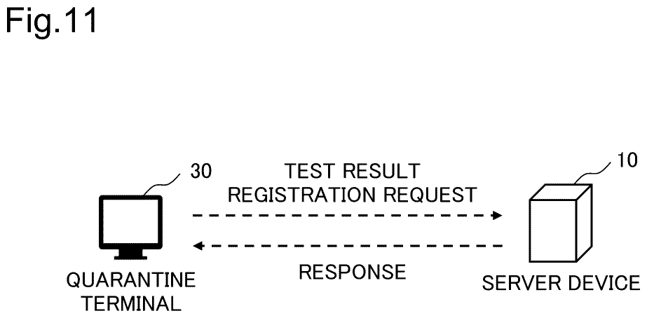

The quarantine terminal 30 transmits a test result registration request including the test kit ID and the test result to the server device 10 (see FIG. 11). The server device 10 identifies the passenger from the acquired test kit ID, and stores the test result (positive, negative) in the passenger information database. The server device 10 that has processed the test result registration request transmits a response to the request to the quarantine terminal 30. When the test result is normally registered, the server device 10 transmits an acknowledgment to the quarantine terminal 30. When the registration of the test result fails, the server device 10 transmits a negative acknowledgment to the quarantine terminal 30.

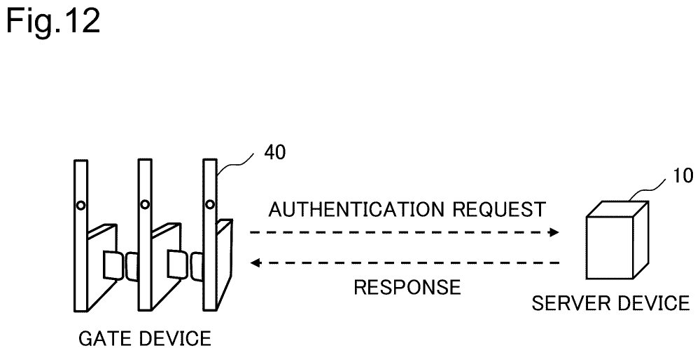

The description returns to FIG. 2. After a lapse of a predetermined time from the submission of the test kit, the passenger moves in front of the gate device 40. Gate device 40 acquires biometric information about the passenger. Gate device 40 transmits an authentication request including the acquired biometric information about the passenger to server device 10 (see FIG. 12).

The server device 10 identifies the authenticatee by biometric authentication, and checks the health condition and the test result of the authenticatee. When the health condition of the authenticatee is “good” and the test result is “negative”, the server device 10 sets the authentication result of the authenticatee to an “authentication success”. In cases other than the above, the server device 10 sets the authentication result to “authentication failure”. For example, if the health condition of the authenticatee is “bad” or the test result is “positive”, the server device 10 sets the authentication result of the authenticatee to “authentication failure”.

The server device 10 transmits a response (acknowledgment, negative acknowledgment) indicating the authentication result (authentication success, authentication failure) to the gate device 40.

When the authentication result represents “authentication success”, the gate device 40 permits the authenticatee to pass through the gate. When the authentication result represents “authentication failure”, gate device 40 does not permit the authenticatee to pass through the gate. In this case, gate device 40 may notify the authentication failure person (the authenticatee determined as the authentication failure) that the person cannot pass through the gate or a handling method (such as reporting to a staff member).

Next, details of each device included in the quarantine system according to the first example embodiment will be described. In the following description, a face image of a passenger or a feature value generated from the face image will be described as an example of the biometric information.

### [Reception Terminal]

As described above, the reception terminal 20 is a device used for system registration of passengers.

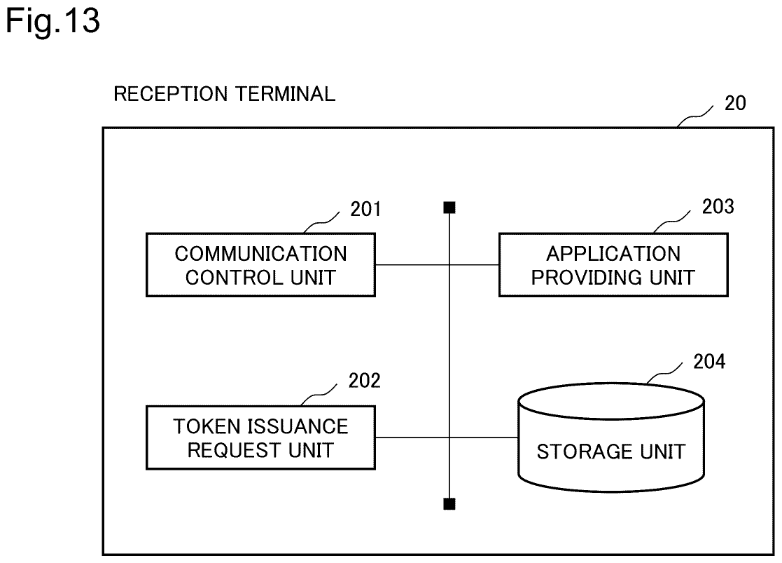

FIG. 13 is a diagram illustrating an example of a processing configuration (processing module) of the reception terminal 20 according to the first example embodiment. Referring to FIG. 13, the reception terminal 20 includes a communication control unit 201, a token issuance request unit 202, an application providing unit 203, and a storage unit 204.

The communication control unit 201 is a means configured to control communication with another device. For example, the communication control unit 201 receives data (packet) from the server device 10. The communication control unit 201 transmits data to the server device 10. The communication control unit 201 delivers data received from another device to another processing module. The communication control unit 201 transmits data acquired from another processing module to another device. In this manner, the another processing module transmits and receives data to and from the another device via the communication control unit 201.

The token issuance request unit 202 is a means configured to request the server device 10 to issue a token of a seeker who desires a quarantine procedure by biometric authentication. The token issuance request unit 202 acquires the passport information (information described in the identification verification document) and the biometric information using a GUI or the like.

The token issuance request unit 202 acquires the passport information from the passport possessed by the passenger. The token issuance request unit 202 controls a reader such as a scanner to acquire information (passport information) described in the passport.

The passport information includes a face image (hereinafter, referred to as a passport face image), a name, a gender, a nationality, a passport number, a passport issuing country, and the like.

Further, the token issuance request unit 202 acquires biometric information about the passenger. More specifically, the token issuance request unit 202 controls the camera to acquire the face image of the passenger.

The token issuance request unit 202 transmits a token issuance request including the passport information and the biometric information to the server device 10.

The token issuance request unit 202 receives a response to the token issuance request from the server device 10. In a case where the negative acknowledgment is received (in a case where the token is not issued), the token issuance request unit 202 notifies the passenger of the fact. At this time, the token issuance request unit 202 may notify the passenger of the cause of the token issue failure. For example, the token issuance request unit 202 may notify the passenger of the fact that the identification has failed.

In a case where the acknowledgment is received (in a case where the token is issued), the token issuance request unit 202 notifies the application providing unit 203 of the fact.

The application providing unit 203 is a means configured to provide a quarantine application to passengers. When the server device 10 issues the token, the application providing unit 203 displays a GUI as illustrated in FIG. 4.

The passenger who sees the display illustrated in FIG. 4 operates the terminal 50 to photograph the displayed two-dimensional code, and downloads the quarantine application to the terminal 50. The terminal 50 installs the downloaded quarantine application.

The storage unit 204 is a means configured to store information necessary for the operation of the reception terminal 20.

### [Terminal]

As described above, the terminal 50 is a terminal possessed by the passenger.

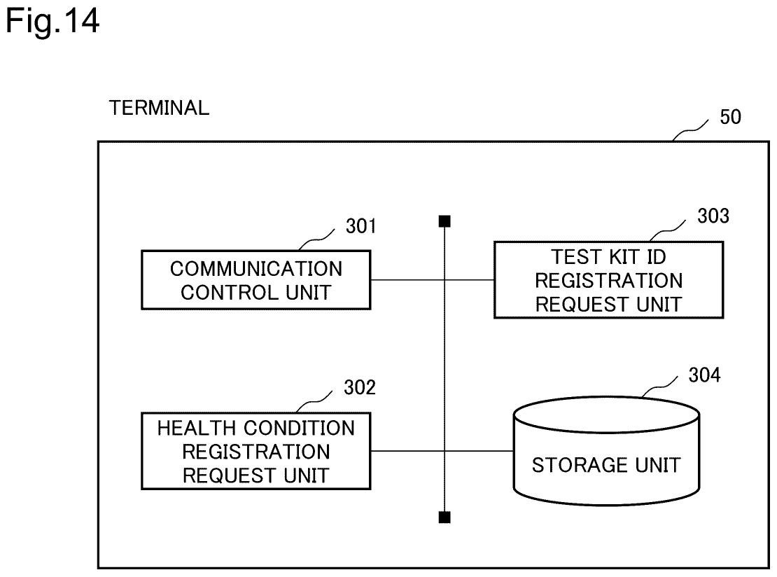

FIG. 14 is a diagram illustrating an example of a processing configuration (processing module) of the terminal 50 according to the first example embodiment. Referring to FIG. 14, the terminal 50 includes a communication control unit 301, a health condition registration request unit 302, a test kit ID registration request unit 303, and a storage unit 304.

The communication control unit 301 is a means configured to control communication with another device. For example, the communication control unit 301 receives data (packet) from the server device 10. The communication control unit 301 transmits data to the server device 10. The communication control unit 301 delivers data received from another device to another processing module. The communication control unit 301 transmits data acquired from another processing module to another device. In this manner, the another processing module transmits and receives data to and from the another device via the communication control unit 301.

The health condition registration request unit 302 is a means configured to register (input) the health condition of the passenger necessary for quarantine in the server device 10. The health condition registration request unit 302 starts an operation when the quarantine application is activated. More specifically, the health condition registration request unit 302 operates when input of health information is selected from a menu of the quarantine application. The health condition registration request unit 302 acquires health information about the passenger using a GUI as illustrated in FIG. 5.

Before or after the acquisition of the health information, the health condition registration request unit 302 acquires the biometric information (face image) of the passenger. For example, the health condition registration request unit 302 acquires a face image of the passenger using a camera (so-called selfie camera) configured to be able to photograph the passenger operating the terminal 50.

The health condition registration request unit 302 may acquire the biometric information using a GUI that clearly indicates (notifies the passenger) that the biometric information (face image) of the passenger is acquired.

The health condition registration request unit 302 transmits a health condition registration request including the acquired biometric information and health information (answer to question) to the server device 10.

The health condition registration request unit 302 outputs a message or the like corresponding to a response (acknowledgment, negative acknowledgment) from the server device 10. When the acknowledgment is received, the health condition registration request unit 302 notifies the passenger that the health condition has been registered normally. For example, the health condition registration request unit 302 performs display as illustrated in FIG. 7.

In a case where the negative acknowledgment is received, the health condition registration request unit 302 notifies the passenger that the health condition has not been registered normally. At this time, the health condition registration request unit 302 may notify the passenger of the cause that the health condition registration request has not being processed normally.

The test kit ID registration request unit 303 is a means configured to register the test kit ID of the test kit delivered to the passenger in the server device 10. The test kit ID registration request unit 303 starts an operation when the quarantine application is activated. More specifically, the test kit ID registration request unit 303 operates when the registration of the test kit ID is selected from the menu of the quarantine application.

The test kit ID registration request unit 303 displays a display for prompting the passenger to photograph a two-dimensional code or the like attached to the delivered test kit. The test kit ID registration request unit 303 decrypts the test kit ID from the two-dimensional code acquired by photographing.

The test kit ID registration request unit 303 transmits a test kit ID registration request including the test kit ID and the biometric information (face image) of the passenger to the server device 10. The biometric information about the passenger may be biometric information acquired by the health condition registration request unit 302, or may be biometric information acquired again by the test kit ID registration request unit 303 before and after the acquisition of the test kit ID.

The test kit ID registration request unit 303 outputs a message or the like corresponding to a response (acknowledgment, negative acknowledgment) from the server device 10. When the acknowledgment is received, the test kit ID registration request unit 303 performs a display to urge the passenger to collect the specimen. For example, the test kit ID registration request unit 303 performs display as illustrated in FIG. 9.

When the negative acknowledgment is received, the test kit ID registration request unit 303 notifies the passenger that the test kit has not been registered normally. At this time, the test kit ID registration request unit 303 may notify the passenger of the cause that the test kit ID registration request is not normally processed. Alternatively, for example, the test kit ID registration request unit 303 may prompt the passenger to photograph the two-dimensional code (test kit ID) given to the test kit again.

The storage unit 304 stores information necessary for the operation of the terminal 50.

### [Quarantine Terminal]

As described above, the quarantine terminal 30 is a terminal used by the quarantine officer.

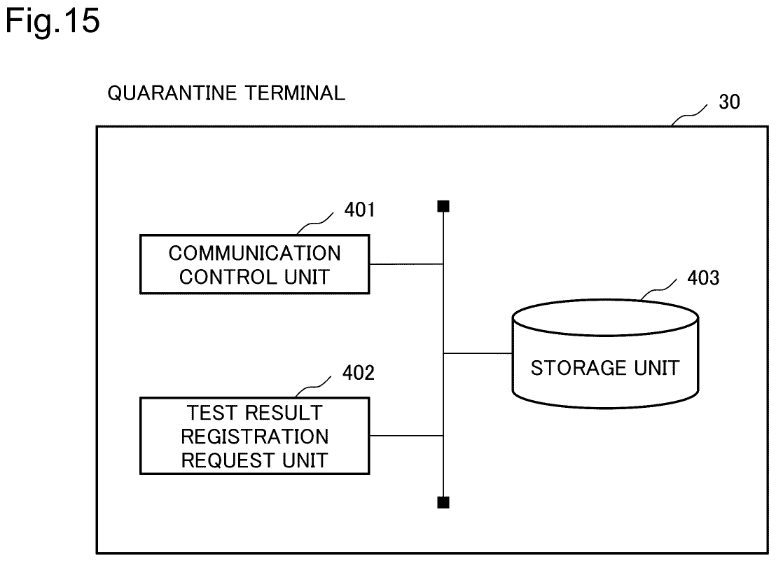

FIG. 15 is a diagram illustrating an example of a processing configuration (processing module) of the quarantine terminal 30 according to the first example embodiment. Referring to FIG. 15, the quarantine terminal 30 includes a communication control unit 401, a test result registration request unit 402, and a storage unit 403.

The communication control unit 401 is a means configured to control communication with another device. For example, the communication control unit 401 receives data (packet) from the server device 10. The communication control unit 401 transmits data to the server device 10. The communication control unit 401 delivers data received from another device to another processing module. The communication control unit 401 transmits data acquired from another processing module to another device. In this manner, the another processing module transmits and receives data to and from the another device via the communication control unit 401.

The test result registration request unit 402 is a means configured to register the test result in the server device 10. The test result registration request unit 402 reads the test kit ID given to the test kit via a barcode reader or the like.

The test result registration request unit 402 displays a GUI for the quarantine officer to input the test result. For example, the test result registration request unit 402 displays a GUI as illustrated in FIG. 10. The test result registration request unit 402 transmits a test result registration request including the acquired test kit ID and the test result to the server device 10.

The test result registration request unit 402 outputs a message or the like corresponding to the response (acknowledgment, negative acknowledgment) from the server device 10. In a case where the acknowledgment is received, the test result registration request unit 402 notifies the quarantine officer that the test result been registered normally.

In a case where the negative acknowledgment is received, the test result registration request unit 402 notifies the quarantine officer that the test result has not been registered normally. At this time, the test result registration request unit 402 may notify the quarantine officer of the cause that the test result has not been normally registered.

The storage unit 403 stores information necessary for the operation of the quarantine terminal 30.

### [Gate Device]

As described above, the gate device 40 is a device that is installed in a quarantine station and controls the gate to restrict passage of passengers.

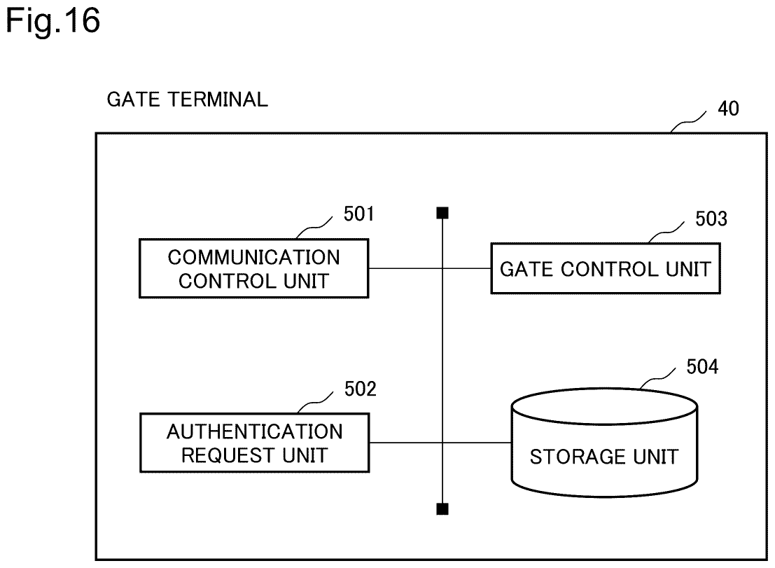

FIG. 16 is a diagram illustrating an example of a processing configuration (processing module) of the gate device 40 according to the first example embodiment. Referring to FIG. 16, the gate device 40 includes a communication control unit 501, an authentication request unit 502, a gate control unit 503, and a storage unit 504.

The communication control unit 501 is a means configured to control communication with another device. For example, the communication control unit 501 receives data (packet) from the server device 10. The communication control unit 501 transmits data to the server device 10. The communication control unit 501 delivers data received from another device to another processing module. The communication control unit 501 transmits data acquired from another processing module to another device. In this manner, the another processing module transmits and receives data to and from the another device via the communication control unit 501.

The authentication request unit 502 is a means configured to request the server device 10 to authenticate the authenticatee (passenger). The authentication request unit 502 controls the camera installed in the own device and acquires the biometric information (face image) of the authenticatee. The authentication request unit 502 transmits an authentication request including biometric information about the authenticatee (passenger) to the server device 10.

The authentication request unit 502 receives a response (acknowledgment, negative acknowledgment) from the server device 10.

When the negative acknowledgment is received, the authentication request unit 502 notifies the passenger that the authentication has failed, for example. For example, the authentication request unit 502 may notify an authentication failure person (an authenticatee determined as an authentication failure) that the person cannot pass through the gate or a handling method (report to a staff member, a quarantine officer, etc.).

When the acknowledgment is received, the authentication request unit 502 notifies the gate control unit 503 of the fact.

The gate control unit 503 is a means configured to control a gate included in the gate device 40. When the result of the authentication request is an authentication success (acknowledgment is received), the gate control unit 503 opens the gate and permits the authenticatee to pass through the gate.

Storage unit 504 is a means configured to store information necessary for the operation of gate device 40.

### [Server Device]

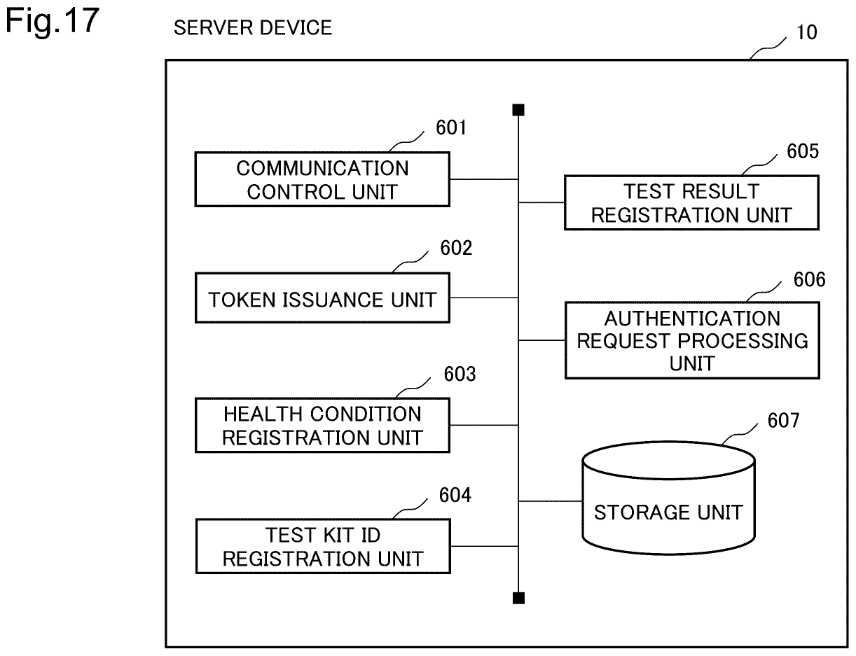

FIG. 17 is a diagram illustrating an example of a processing configuration (processing module) of the server device 10 according to the first example embodiment. Referring to FIG. 17, the server device 10 includes a communication control unit 601, a token issuance unit 602, a health condition registration unit 603, a test kit ID registration unit 604, a test result registration unit 605, an authentication request processing unit 606, and a storage unit 607.

The communication control unit 601 is a means configured to control communication with another device. For example, the communication control unit 601 receives data (packet) from the reception terminal 20. The communication control unit 601 transmits data to the reception terminal 20. The communication control unit 601 delivers data received from another device to another processing module. The communication control unit 601 transmits data acquired from another processing module to another device. In this manner, the another processing module transmits and receives data to and from the another device via the communication control unit 601. The communication control unit 601 functions as an acquisition unit that acquires information (biometric information about each of the plurality of users, test results necessary for quarantine, and the like) from various requests (for example, a token issuance request and a test result registration request).

The token issuance unit 602 is a means configured to issue a token in response to a token issuance request from the reception terminal 20. The token issuance unit 602 checks identification of a passenger who performs a procedure at the reception terminal 20.

Specifically, the token issuance unit 602 determines whether a person who presented the passport to the reception terminal 20 and a person who received the issuance of the passport are the same person. The token issuance unit 602 checks that the passenger does not present the passport issued to another person to the reception terminal 20.

The token issuance unit 602 determines whether the two face images (passport face image, captured face image captured by the reception terminal 20) included in the token issuance request substantially match.

The token issuance unit 602 executes collation (one-to-one collation) of the two face images. The token issuance unit 602 calculates a feature value (feature vector) from each of the two images. The token issuance unit 602 calculates similarity (for example, Euclidean distance between feature vectors) between the two images, and determines whether the two images are face images of the same person based on a result of the threshold value process on the calculated similarity. For example, in a case where the similarity is larger than a predetermined value (in a case where the distance is shorter than the predetermined value), the token issuance unit 602 determines that the two face images are of the same person.

When the above determination is successful, the token issuance unit 602 issues a token. For example, the token issuance unit 602 generates a unique value as the token ID based on the date and time, the sequence number, and the like at the time of processing.

Upon generating the token (token ID), the token issuance unit 602 transmits an acknowledgment response (token issue) to the reception terminal 20. When failing to generate the token ID, the token issuance unit 602 transmits a negative acknowledgment (no token issue) to the reception terminal 20. For example, when the face image of the passport and the face image photographed by the reception terminal 20 are the face images of different persons, the negative acknowledgment is transmitted to the reception terminal 20. The token issuance unit 602 may transmit, to the reception terminal 20, the negative acknowledgment including a cause of the token failure. For example, the token issuance unit 602 may notify the reception terminal 20 of the fact that the identification has failed.

When the token ID is successfully generated (issued), the token issuance unit 602 stores the token ID and the biometric information about the passenger (face image, feature value) in the passenger information database. The token issuance unit 602 adds a new entry to the passenger information database, and registers the token ID and the biometric information in the database.

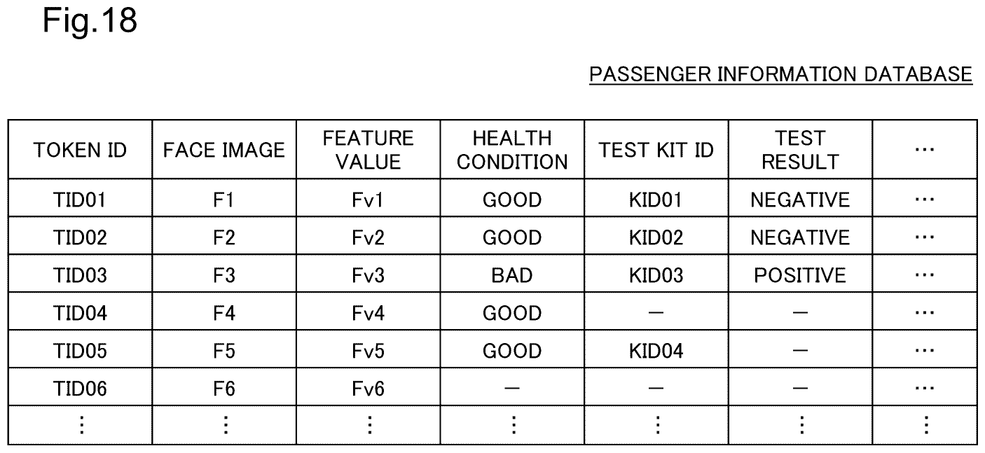

FIG. 18 is a diagram illustrating an example of the passenger information database according to the first example embodiment. As illustrated in FIG. 18, the passenger information database stores a token ID, biometric information (face image, feature value), a health condition, a test kit ID, a test result, and the like in association with each other.

The face image registered in the passenger information database may be a passport face image or a captured face image captured by the reception terminal 20. Regarding the feature value, the feature value generated from the passport face image may be registered, or the feature value generated from the captured face image may be registered.

In FIG. 18, the fact that there is no problem in the health condition is expressed as “good”, and the fact that there is a problem in the health condition is expressed as “bad”. “-” is described in a field in which no value is set depending on the progress status of the procedure.

The passenger information database illustrated in FIG. 18 is an example and is not intended to limit the content of the database. For example, the face image may not be registered in the passenger information database, or the name, the date of birth, the nationality, and the like obtained from the passport information may be registered in the passenger information database.

In this manner, the token issuance unit 602 receives the token issuance request including the first biometric information about the seeker who wants to proceed with the quarantine procedure by the biometric authentication and the second biometric information described in the identification verification document (passport) of the seeker. When the identification of the seeker is successfully confirmed based on the two pieces of biometric information, the token issuance unit 602 issues a token ID for identifying the seeker. The token issuance unit 602 registers the issued token ID and the biometric information about the seeker in the passenger information database in association with each other.

The health condition registration unit 603 is a means configured to register the health condition of the passenger in response to the health condition registration request from the terminal 50.

The health condition registration unit 603 extracts biometric information (face image) of the passenger from the health condition registration request. The health condition registration unit 603 generates a feature value from the extracted face image. An existing technique can be used for the feature value generation process, and thus a detailed description thereof will be omitted. For example, the health condition registration unit 603 extracts eyes, a nose, a mouth, and the like as feature points from the face image. Thereafter, the health condition registration unit 603 calculates the position of each feature point and the distance between the feature points as feature values, and generates a feature vector including a plurality of feature values.

The health condition registration unit 603 sets the generated feature value (feature vector) as the feature value on the collation side and sets the feature value registered in the passenger information database as the feature value on the registration side. The health condition registration unit 603 calculates similarity between the feature value on the collation side and each of the plurality of feature values on the registration side. A chi-square distance, a Euclidean distance, or the like can be used as the degree of similarity. The degree of similarity is lower, the distance is longer, and the degree of similarity is higher, the distance is shorter.

The health condition registration unit 603 determines that the collation is successful when there is a feature value, among the plurality of feature values registered in the passenger information database, whose similarity with a feature value to be collated is equal to or greater than a predetermined value.

The health condition registration unit 603 determines the health condition of the passenger from the health information included in the health condition registration request. For example, in a case where answers to the question items illustrated in FIG. 5 are transmitted as health information, the health condition registration unit 603 sets the health condition of the passenger to “good” in a case where both of the two answers to the question are “YES”. On the other hand, when at least one of the two questions is “NO”, the health condition registration unit 603 sets the health condition of the passenger to “bad”.

The health condition registration unit 603 stores the determined health condition in the health condition field of the entry of the passenger identified by the collation process.

When the health condition is normally stored in the passenger information database (when the health condition registration request is normally processed), the health condition registration unit 603 transmits an acknowledgment to the terminal 50.

When the health condition cannot be normally stored in the passenger information database (when the health condition registration request is not normally processed), the health condition registration unit 603 transmits a negative acknowledgment to the terminal 50. For example, the health condition registration unit 603 transmits a negative acknowledgment to the terminal 50 in a case where the collation process has failed, health information sufficient for determining health information has not been transmitted (answer is insufficient), or the like. The health condition registration unit 603 may transmit, to the terminal 50, a negative acknowledgment including a cause for which the health condition registration request cannot be normally processed.

In this manner, the health condition registration unit 603 receives the health condition registration request including the information about the health of the user (second user) and the biometric information about the user. The health condition registration unit 603 determines the health condition of the user based on the information about the health. The health condition registration unit 603 identifies the user whose health condition is to be register from among the plurality of users using the biometric information about each of the plurality of users stored in the passenger information database and the biometric information about the user acquired from the terminal 50. The health condition registration unit 603 registers the biometric information about the identified user and the determined health condition in the passenger information database in association with each other.

The test kit ID registration unit 604 is a means configured to register a test kit ID in response to a test kit ID registration request from the terminal 50. As in the health condition registration unit 603, the test kit ID registration unit 604 identifies the passenger from the biometric information included in the test kit ID registration request. Specifically, the test kit ID registration unit 604 identifies the passenger by the collation process using the biometric information included in the test kit ID registration request and the biometric information registered in the passenger information database.

The test kit ID registration unit 604 stores the test kit ID included in the test kit ID registration request in the entry of the passenger identified by the collation process.

When the test kit ID is normally stored in the passenger information database (when the test kit ID registration request is normally processed), the test kit ID registration unit 604 transmits an acknowledgment to the terminal 50.

When the test kit ID cannot be normally stored in the passenger information database (when the test kit ID registration request is not normally processed), the test kit ID registration unit 604 transmits a negative acknowledgment to the terminal 50. For example, the test kit ID registration unit 604 transmits a negative acknowledgment to the terminal 50 in a case where the value of the test kit ID that has failed in the collation process is not normal (a value that the test kit ID cannot take) or the like. The test kit ID registration unit 604 may transmit a negative acknowledgment including a reason why the test kit ID registration request cannot be normally processed to the terminal 50.

As described above, the test kit ID registration unit 604 receives the test kit ID registration request including the test kit ID given to the test kit for performing the test necessary for quarantine and the biometric information about the user (first user) who uses the test kit. The test kit ID registration unit 604 identifies the user from among the plurality of users using the biometric information about each of the plurality of users stored in the passenger information database and the biometric information about the user included in the test kit ID registration request. The test kit ID registration unit 604 registers the biometric information about the identified user and the test kit ID included in the test kit ID registration request in the passenger information database in association with each other.

The test result registration unit 605 is a means configured to register a test result in response to a test result registration request from the quarantine terminal 30. The test result registration unit 605 extracts the test kit ID from the test result registration request. The test result registration unit 605 searches the passenger information database using the test kit ID as a key, and identifies a corresponding entry.

The test result registration unit 605 stores the test result (positive, negative) included in the test result registration request in the test result field of the identified entry.

When the test result is normally stored in the passenger information database (when the test result registration request is normally processed), the test result registration unit 605 transmits an acknowledgment to the quarantine terminal 30.

When the test result cannot be normally stored in the passenger information database (when the test result registration request is not normally processed), the test result registration unit 605 transmits a negative acknowledgment to the quarantine terminal 30. For example, in a case where the test kit ID is not registered in the database, the test result registration unit 605 transmits a negative acknowledgment to the quarantine terminal 30. The test result registration unit 605 may transmit, to the quarantine terminal 30, a negative acknowledgment including a cause for which the test result registration request cannot be normally processed.

As described above, the test result registration unit 605 receives, from the quarantine terminal 30 used by the quarantine officer, the test result registration request including the test kit ID given to the test kit for which the test necessary for quarantine has ended and the test result of the quarantine test. The test result registration unit 605 searches the passenger information database using the test kit ID included in the test result registration request as a key, and registers the test result included in the test result registration request in the identified entry.

The authentication request processing unit 606 is a means configured to process the authentication request acquired from the gate device 40.

The authentication request processing unit 606 receives the authentication request including the biometric information about the authenticatee from the gate device 40, and identifies the authenticatee from the plurality of users using the biometric information about each of the plurality of users and the biometric information about the authenticatee stored in the passenger information database. The authentication request processing unit 606 determines a result of the authentication request based on at least a test result of the identified authenticatee. The authentication request processing unit 606 transmits the determined authentication result to the gate device 40.

The authentication request includes biometric information about the authenticatee. As in the health condition registration unit 603, the authentication request processing unit 606 performs a collation process (one-to-N collation where N is a positive integer) using the biometric information included in the authentication request and the biometric information included in the passenger information database.

When the collation fails, the authentication request processing unit 606 sets the authentication result to “authentication failure”.

When the collation is successful, the authentication request processing unit 606 identifies the entry of the passenger information database corresponding to the feature value having the highest similarity. The authentication request processing unit 606 reads values from the health condition field and the test result field of the identified entry.

When the health condition is “good” and the test result is “negative”, the authentication request processing unit 606 sets the authentication result to “authentication success”.

When the health condition is “bad” or the test result is “positive”, the authentication request processing unit 606 sets the authentication result to “authentication failure”.

The authentication request processing unit 606 transmits a response to the authentication request to the gate device 40. When the authentication is successful, authentication request processing unit 606 transmits the acknowledgment to the gate device 40. When the authentication fails, the authentication request processing unit 606 transmits a negative acknowledgment to the gate device 40. When the negative acknowledgment is transmitted, the authentication request processing unit 606 may transmit, to the gate device 40, the negative acknowledgment including the cause of the authentication failure. For example, the authentication request processing unit 606 may notify the gate device 40 of the cause such as the biometric information is not registered in the passenger information database, there is a problem in the health condition, or the test result is “positive”.

The storage unit 607 stores various types of information necessary for the operation of the server device 10. The passenger information database is constructed in the storage unit 607. The passenger information database stores the biometric information, the test result, the health condition, and the like of each of the plurality of users registered in the system in association with each other.

### [System Operation]

Next, an operation of the quarantine system according to the first example embodiment will be described.

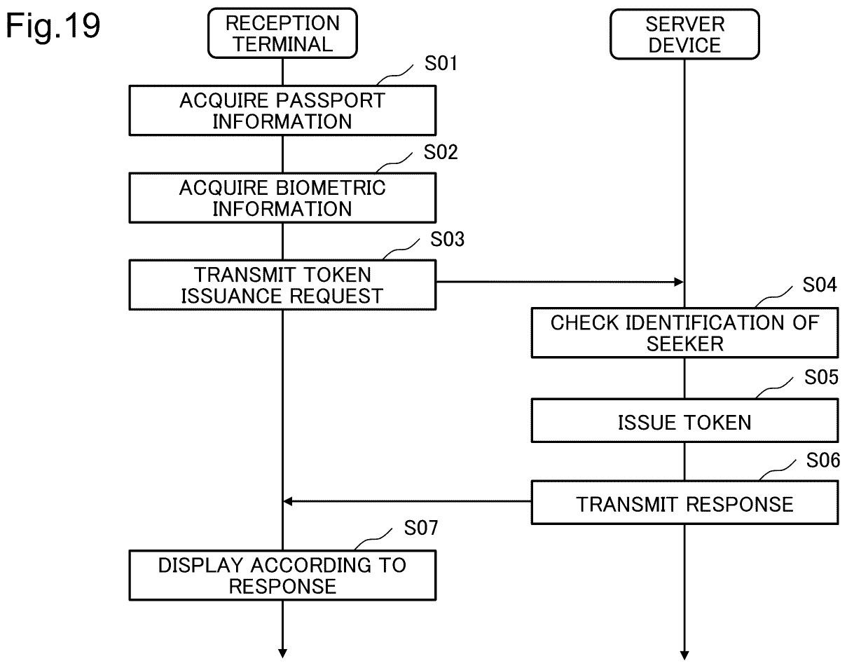

FIG. 19 is a sequence diagram illustrating an example of an operation of the quarantine system according to the first example embodiment. A system operation at the time of issuing a token will be described with reference to FIG. 19.

The reception terminal 20 acquires the passport information and the biometric information about the passenger (seeker who desires system registration) (steps S01 and S02).

The reception terminal 20 transmits a token issuance request including the passport information and the biometric information to the server device 10 (step S03).

The server device 10 checks identification of a seeker who desires system registration (step S04). Specifically, server device 10 checks the identification by one-to-one collation using the passport face image and the captured face image. In a case where the one-to-one collation is successful, the server device 10 determines that the identification is successfully confirmed.

When the identification is successfully confirmed, the server device 10 issues a token for identifying the seeker of the system registration (step S05).

The server device 10 transmits a response to the token issuance request to the reception terminal 20 (step S06).

The reception terminal 20 displays a message or the like according to the received response (step S07).

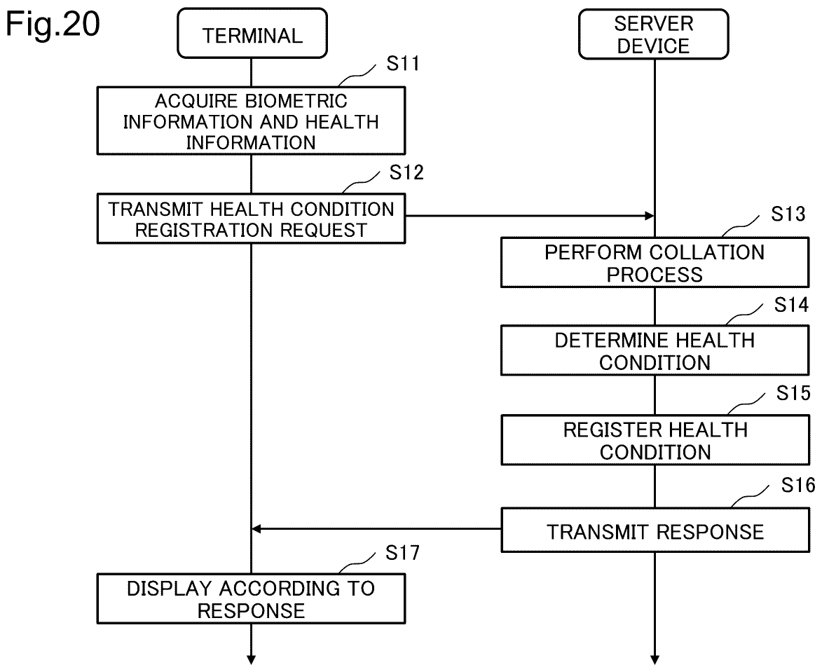

FIG. 20 is a sequence diagram illustrating an example of an operation of the quarantine system according to the first example embodiment. With reference to FIG. 20, a system operation for registering the health condition of the passenger will be described.

The terminal 50 acquires biometric information and health information about the passenger (step S11).

The terminal 50 transmits a health condition registration request including the biometric information and the health information to the server device 10 (step S12).

The server device 10 identifies the passenger whose health condition is to be registered by the collation process using the biometric information included in the health condition registration request (execution of the collation process; step S13).

The server device 10 determines the health condition of the passenger based on the health information about the passenger (answer to the question about health) (step S14).

The server device 10 registers the health condition of the passenger in the passenger information database (step S15).

Server device 10 transmits a response to the health condition registration request to terminal 50 (step S16).

The terminal 50 displays a message or the like according to the received response (step S17).

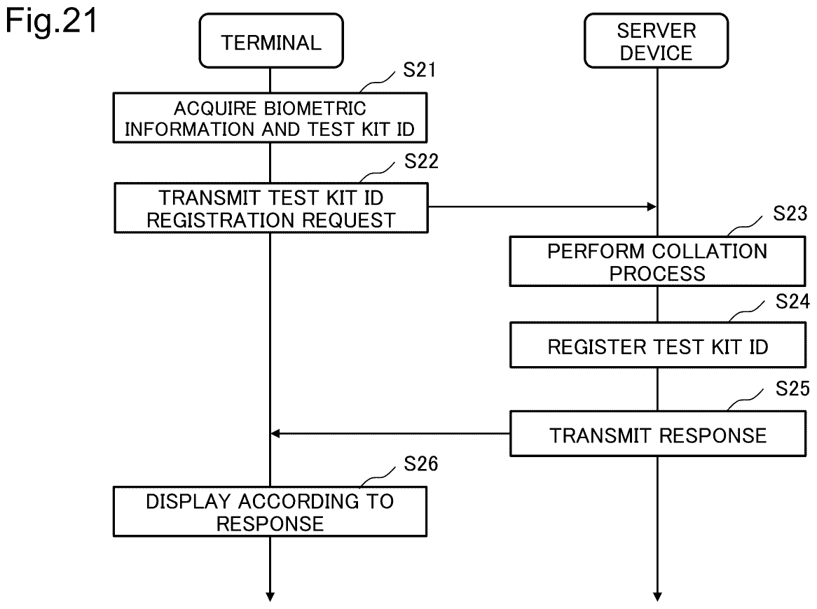

FIG. 21 is a sequence diagram illustrating an example of an operation of the quarantine system according to the first example embodiment. With reference to FIG. 21, a system operation when registering a test kit ID of a test kit used by the passenger will be described.

The terminal 50 acquires the biometric information about the passenger and the test kit ID (step S21).

The terminal 50 transmits a test kit ID registration request including the biometric information and the test kit ID to the server device 10 (step S22).

The server device 10 identifies the passenger whose test kit ID is registered by the collation process using the biometric information included in the test kit ID registration request (execution of the collation process; step S23).

The server device 10 registers the test kit ID in the passenger information database (step S24).

The server device 10 transmits a response to the test kit ID registration request to the terminal 50 (step S25).

The terminal 50 displays a message or the like according to the received response (step S26).

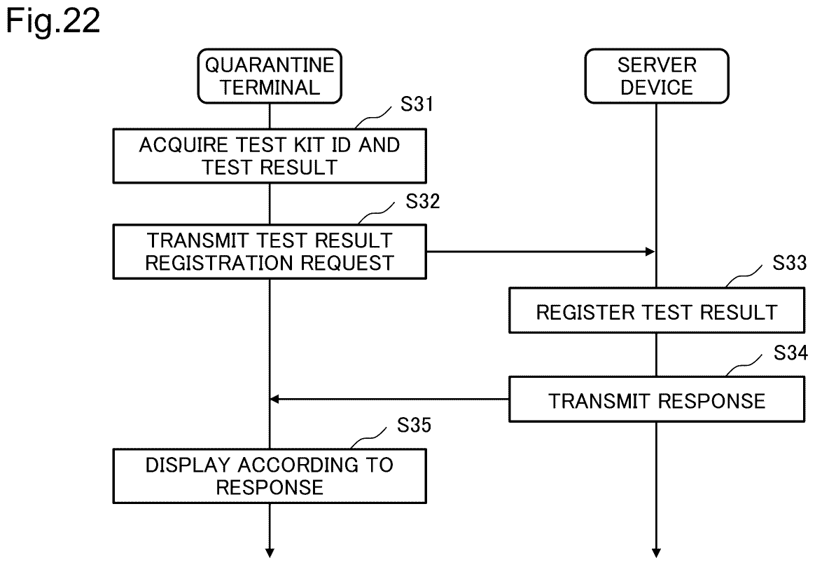

FIG. 22 is a sequence diagram illustrating an example of an operation of the quarantine system according to the first example embodiment. A system operation when registering a test result will be described with reference to FIG. 22.

The quarantine terminal 30 acquires the test kit ID and the test result (step S31).

The quarantine terminal 30 transmits a test result registration request including the test kit ID and the test result to the server device 10 (step S32).

The server device 10 identifies an entry from the test kit ID and registers the test result in the passenger information database (step S33).

The server device 10 transmits a response to the test result registration request to the quarantine terminal 30 (step S34).

The quarantine terminal 30 displays a message or the like according to the received response (step S35).

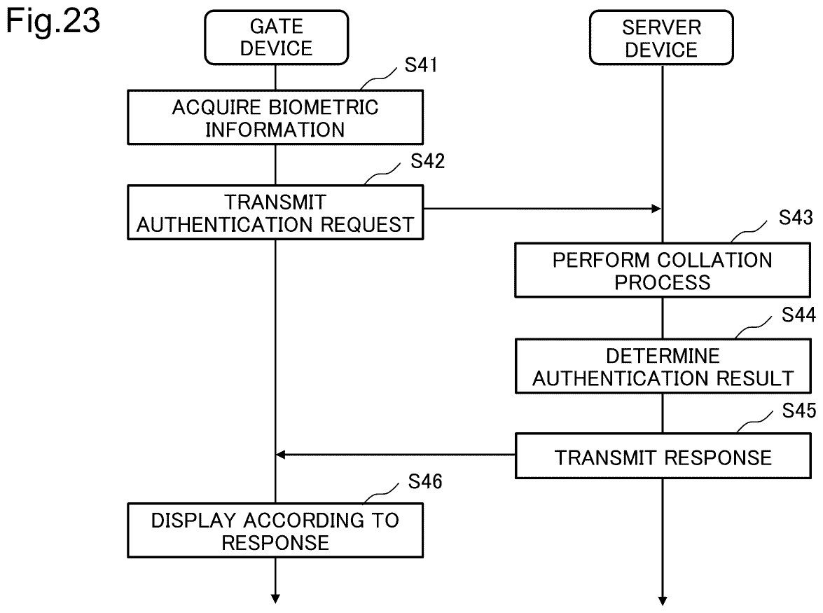

FIG. 23 is a sequence diagram illustrating an example of an operation of the quarantine system according to the first example embodiment. A system operation when processing an authentication request will be described with reference to FIG. 23.

Gate device 40 acquires the biometric information about the user (step S41).

Gate device 40 transmits an authentication request including the biometric information about the user to server device 10 (step S42).

The server device 10 executes the collation process using the acquired biometric information and the biometric information stored in the passenger information database, and identifies the authenticatee (execution of the collation process; step S43).

The server device 10 determines an authentication result related to the authenticatee based on the health condition and the test result of the identified authenticatee (step S44).

The server device 10 transmits a response to the authentication request to the gate device 40 (step S45).

The gate device 40 displays a message or the like according to the received response (step S46).

As described above, in the quarantine system according to the first example embodiment, the user answers a question about health using the quarantine application. The server device 10 determines the health condition of the user based on the answer to the question, and registers the health condition in the passenger information database. The user registers the test kit ID of the test kit used for the user's own test in the server device 10 using the quarantine application. The quarantine officer registers the result of the test using the test kit in the server device 10. When processing the authentication request from the gate device 40, the server device 10 refers to the health condition and the test result of the authenticatee (user who has been quarantined). When determining that the authenticatee is not suffering from an infectious disease or the possibility thereof is low from these pieces of information, the server device 10 notifies the gate device 40 of the authentication success. The gate device 40 permits an authentication successful person (an authenticatee who is determined to be authenticated successfully) to pass through the gate. As described above, in the first example embodiment, the user registers the information regarding the health condition and the test kit ID in the system by himself/herself. In other words, it is not necessary for the quarantine officer to hear the health condition from the user or register the information about the test kit in the system. As a result, the quarantine officer can be dedicated to the quarantine operation (test operation), thereby improving the efficiency of the system.

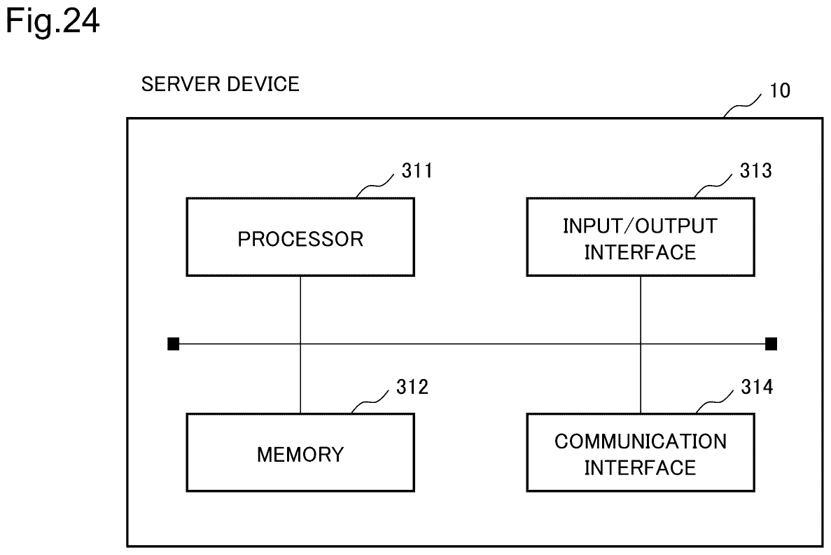

Next, hardware of each device constituting the quarantine system will be described. FIG. 24 is a diagram illustrating an example of a hardware configuration of the server device 10.

The server device 10 can be configured by an information processing device (so-called computer), and has the configuration illustrated in FIG. 24. For example, the server device 10 includes a processor 311, a memory 312, an input/output interface 313, a communication interface 314, and the like. The components such as the processor 311 are connected by an internal bus or the like and are configured to be able to communicate with each other.

However, the configuration illustrated in FIG. 24 is not intended to limit the hardware configuration of the server device 10. The server device 10 may include hardware not illustrated or may not include the input/output interface 313 as necessary. The number of processors 311 and the like included in the server device 10 is not limited to the example of FIG. 24, and for example, a plurality of processors 311 may be included in the server device 10.

The processor 311 is a programmable device such as a central processing unit (CPU), a micro processing unit (MPU), or a digital signal processor (DSP). Alternatively, the processor 311 may be a device such as a field programmable gate array (FPGA) or an application specific integrated circuit (ASIC). The processor 311 executes various kinds of programs including an operating system (OS).

The memory 312 is a random access memory (RAM), a read only memory (ROM), a hard disk drive (HDD), a solid state drive (SSD), or the like. The memory 312 stores an OS program, an application program, and various pieces of data.

The input/output interface 313 is an interface of a display device or an input device (not illustrated). The display device is, for example, a liquid crystal display or the like. The input device is, for example, a device that receives a user operation such as a keyboard or a mouse.

The communication interface 314 is a circuit, a module, or the like that communicates with another device. For example, the communication interface 314 includes a network interface card (NIC) or the like.

The functions of the server device 10 are implemented by various processing modules. The processing module is implemented, for example, by the processor 311 executing a program stored in the memory 312. The program can be recorded in a computer-readable storage medium. The storage medium may be a non-transient medium such as a semiconductor memory, a hard disk, a magnetic recording medium, or an optical recording medium. That is, the present invention can also be embodied as a computer program product. The program can be downloaded via a network or updated using a storage medium storing the program. Furthermore, the processing module may be achieved by a semiconductor chip.

The reception terminal 20 and the like can also be configured by an information processing device as in the server device 10, and since there is no difference in the basic hardware configuration from the server device 10, the description thereof will be omitted. The reception terminal 20 or the like may include a camera or the like.

The server device 10 includes a computer, and the function of the server device 10 can be achieved by causing the computer to execute a program. The server device 10 executes the server device controlling method by the program.

### [Modification]

The configuration, operation, and the like of the quarantine system described in the above example embodiment are merely examples, and are not intended to limit the configuration and the like of the system.

In the above example embodiment, the case where the server device 10 has the passenger information database is described. However, the passenger information database may be constructed in a database server different from the server device 10. The quarantine system may include the various means (token issuance unit 602, health condition registration unit 603, and the like) described in the above example embodiment.

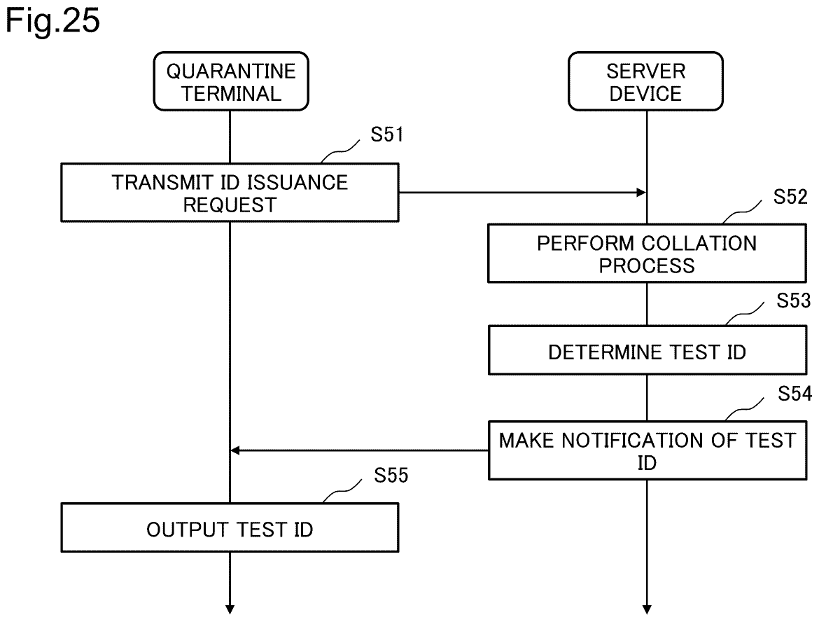

In the above example embodiment, it is described that the passenger photographs the test kit ID to transmit the test kit ID together with his/her own biometric information to the server device 10. However, the method for registering the test kit ID is merely an example, and is not intended to limit the method for registering the test kit ID. Hereinafter, a method for registering a test kit ID will be described with reference to the drawings. As illustrated in FIG. 25, for example, the quarantine terminal 30 acquires biometric information about a person to be quarantined (a passenger who is quarantined) to transmit an “ID issuance request” including the biometric information to the server device 10 (step S51). The server device 10 executes the collation process using the acquired biometric information to identify the person to be quarantined (execution of the collation process; step S52). The server device 10 determines a test ID (an ID given to the test kit) corresponding to the identified person to be quarantined (step S53). The server device 10 notifies the quarantine terminal 30 of the determined test ID (step S54). The quarantine terminal 30 outputs the notified test ID (step S55). For example, the quarantine terminal 30 prints the notified test ID as a label. The quarantine officer or the person to be quarantined attaches the output label to the test kit. Alternatively, the quarantine terminal 30 may directly print the test ID notified from the server device 10 on the test kit to output the test kit on which the test ID is printed. More specifically, the quarantine terminal 30 may provide the passenger with a test kit to which a test ID is given, like a vending machine such as a beverage. That is, the vending machine type quarantine terminal 30 may transmit the biometric information about the passenger to the server device 10, and output the test kit on which the test ID determined by the server device 10 is printed. The passenger who receives the test kit from the vending machine type quarantine terminal 30 may not give the test kit storing the specimen to the quarantine officer but may put the test kit to a predetermined place. Alternatively, the passenger may put the test kit storing the specimen in the vending machine type quarantine terminal 30. The test kit accommodated in the quarantine terminal 30 may be automatically tested, and the test result may be attached to the test kit. The attached test result and test ID may be transmitted to the server device 10, and the test result may be registered in the server device 10. Such handling without human intervention (unmanned handling by a machine) eliminates the need for a quarantine officer and can prevent the quarantine officer from suffering from an infectious disease.

In addition to determining that the biometric authentication has failed for the user who cannot pass the quarantine, the server device 10 may guide the user to another isolation place different from the quarantine station. The guidance may be provided via the gate device 40 or may be provided via a pre-registered contact (for example, an email address receivable by the terminal 50).

In the above example embodiment, it is described that a token (system registration of the user) generated via the reception terminal 20 is used for the quarantine procedure using biometric authentication. However, the token may be used for a customs procedure and an immigration inspection procedure subsequent to a quarantine procedure. That is, the user can also receive a customs procedure, an immigration inspection, and the like by biometric authentication.

In the above example embodiment, it is described that the passage of a user suffering from an infectious disease or the like is blocked by the gate device 40 installed in the quarantine station. However, the passage block of the user may be achieved by a gate device installed in a place other than the quarantine station. For example, the gate device 40 may not be installed in a quarantine station, and passage of passengers (passengers who have not been successfully quarantined and passengers who cannot enter the country) suffering from an infectious disease may be blocked by a gate device installed at an immigration office or a customs office. That is, the quarantine result may be reflected in the authentication result at the time of the immigration inspection or the customs examination.

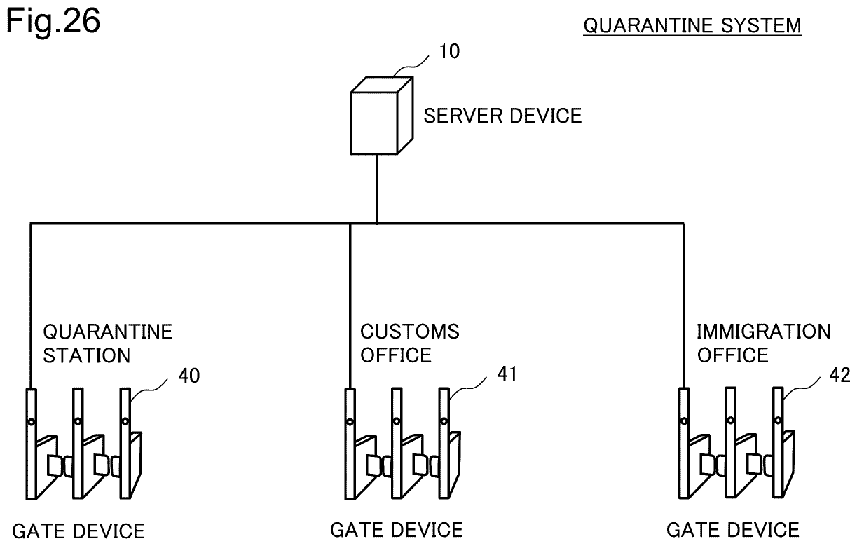

Alternatively, as illustrated in FIG. 26, the gate device 40 to 42 may be installed in each of a quarantine station, a customs office, and an immigration office. For the authentication request from each gate device 40 to 42, the server device 10 may set, as a condition for the authentication success, that the quarantine of the authenticatee has succeeded. Alternatively, only in the biometric authentication by the immigration office, the server device 10 may set the success of the quarantine as the condition of the authentication success. In the example of FIG. 26, passengers (entrants) can pass through the gate device and the gate device 41 before the test result is confirmed. However, a passenger who can pass through gate device 42 is limited to a passenger whose test result is confirmed and whose quarantine is normally finished (a passenger who is not suffering from an infectious disease or the like). With such a response, it is possible to prevent passengers waiting for a test result from overflowing into the quarantine station. In other words, since it takes time to test the specimen, it is possible to secure the test time by using the gate device 40 as a place of the final determination of whether the passenger can pass.

The server device 10 may determine whether the person to be quarantined corresponding to the request can pass through the gate device 40 at the timing when the test result registration request is received from the quarantine terminal 30. In this case, the server device 10 may notify the terminal 50 (a quarantine application) possessed by a person to be quarantined (passenger) of the determination result. The passenger who has received the notification that the passage through the gate is permitted goes to the gate device 40, leaves the quarantine station, and proceeds to the next procedure. The passenger who has received the notification that passage of the gate is not permitted inquires a staff member or a quarantine officer waiting in the quarantine station about how to coping with the problem.

The server device 10 may notify the passengers that the quarantine has ended by using a digital signage installed in a quarantine station or a waiting room of the user waiting for the quarantine result. For example, when the name of the passenger acquired from the passport is registered in the passenger information database, the server device 10 may display the completion of the test on the digital signage together with the name of the passenger who has finished the test. When the name of the passenger is not registered in the passenger information database, the server device 10 may notify the passenger of the completion of the test by using a time zone in which the passenger passes the test kit to the quarantine officer (a time zone in which the test kit ID registration request is transmitted to the server device 10) or the like. For example, the server device 10 may output a message such as “the examination of the customer who submitted the specimen at 13:00 to 14:00 is finished” to the digital signage. Alternatively, the server device 10 may output the test kit ID of the test kit whose test has been completed to the digital signage. For example, the server device 10 may display a message such as “test completed: KID01 to KID03” on the digital signage. Alternatively, the server device 10 may predict the test end time from the time zone in which the passenger submits the test kit, and display the remaining time for determining the test result on the signage. Alternatively, the server device 10 may notify the terminal 50 of the message and the remaining time to be displayed on the digital signage. In this manner, the server device 10 may notify the passenger via the terminal 50 (quarantine application) or the digital signage of the fact of the progress of the test, the remaining time until the end of the test, and the end of the test. Alternatively, the server device 10 may display a two-dimensional code or the like including information such as the test end time on the digital signage. The passenger may operate the terminal 50 to photograph the two-dimensional code, and decode the test end time and the like from the two-dimensional code. Furthermore, the server device 10 may prepare an interface that inquires the passenger about the test end time and the like. Specifically, the passenger operates the terminal 50 (quarantine application) to transmit his/her own biometric information to the server device 10. The server device 10 identifies the passenger by the collation process using the biometric information to transmit the test end time of the passenger to the terminal 50. Alternatively, the digital signage may acquire biometric information about the passenger to transmit the biometric information to the server device 10. The server device 10 may identify the passenger by biometric authentication using the biometric information to transmit the test end time and the like to the digital signage. That is, the display of the test end time and the remaining time on the digital signage may be achieved by face authentication using biometric information acquired from a camera installed in the digital signage.

The server device 10 may provide information useful for the passenger to the passenger waiting until the test result is obtained. For example, server device 10 may provide the information based on the passport information or the information about the passenger boarding (information obtained from a departure control system (DCS)). More specifically, the server device 10 may output tourism guidance or the like at the destination (destination country) of each passenger to the terminal 50 or the digital signage.

In the above example embodiment, it is described that the gate device 40 installed in a quarantine station controls passage of passengers. However, the gate device 40 may not be installed in the quarantine station, but a staff member or the like may control passage of passengers. Specifically, the staff member operates the terminal that he/she possesses to acquire the biometric information about the passenger, and requests the server device 10 for authentication. When the response from the server device 10 is “acknowledgment (authentication success)”, the staff member permits the passenger to pass. As described above, a physical gate may not be installed in the quarantine station, but the staff member may control passage of passengers according to an authentication result of the server device 10.

In the above example embodiment, it is described that the token is issued using the reception terminal 20. However, the token may be issued by the terminal 50 instead of the reception terminal 20. Terminal 50 may acquire the biometric information and the passport information about the user to transmit a token issuance request including these pieces of information to the server device 10. With such a response, even when the terminal 50 such as a smartphone cannot be used immediately (for example, in a case where the terminal 50 is out of the range) as in a foreigner, the passenger can receive a quarantine procedure using biometric authentication.

Alternatively, instead of the terminal 50, the reception terminal 20 may acquire the health information about the user to transmit the health condition registration request to the server device 10. Similarly, the quarantine terminal 30 may read the test kit ID given to the test kit to transmit the test kit ID registration request to the server device 10. That is, the foreigner or the like can register the test kit ID in the server device 10 without using the terminal 50.

The server device 10 may acquire information about a visa in addition to the passport information about the user at the time of issuing the token. The server device 10 may set the fact that the user has a correct visa as a requirement for issuing the token.

In the above example embodiment, the quarantine as to whether the entrant suffers from an infectious disease has been mainly described. However, the present disclosure can also be applied to another quarantine, for example, quarantine of food and the like. Specifically, as in the test kit ID, the terminal 50 photographs a food quarantine ID given to food to be brought into the country, and transmits a food quarantine ID registration request including the ID and biometric information about the user to the server device 10. The server device 10 registers the ID in the passenger information database in association with the biometric information about the user. The quarantine officer registers the food quarantine ID of the food for which the quarantine has been terminated and the quarantine result in the server device 10. Server device 10 may add the fact that food quarantine is successful to the condition for the authentication request from gate device 40 to be an authentication success.

In the above example embodiment, with reference to FIG. 10, the interface in a case where the quarantine officer registers the test result related to one test kit in the server device 10 is described. However, the quarantine terminal 30 may provide the quarantine officer with an interface for inputting test results regarding a plurality of test kits together. Alternatively, in a case where a label indicating a test result is attached to the test kit whose test has been completed, the quarantine terminal 30 may acquire the test kit ID and the test result (negative, positive) together. That is, the test result may be automatically registered in the system without manual intervention (instead of the quarantine officer inputting the test result). In this case, it is not necessary to display the GUI as illustrated in FIG. 10.

In the above example embodiment, the description has been made on the assumption that the passenger who has received the test kit from the quarantine officer collects the specimen on the spot. However, the area (reception area) in which the test kit is delivered to the passenger and the area (specimen collection booth) in which the specimen is collected may be different. In this case, the server device 10 may include information about the specimen collection booth in the response to the “test kit ID registration request”. For example, in a case where a plurality of specimen collection booths is installed, the server device 10 may select a usable specimen collection booth to transmit information about the selected booth to the terminal 50. When performing the display illustrated in FIG. 9, the terminal 50 may also display the information about the notified specimen collection booth (for example, booth number), or may provide guidance in such a way that the user enters the booth after the preceding booth user leaves the booth if the booth is in use.

In the above example embodiment, the case where the face image of the passenger as the biometric information is transmitted to the server device 10 is described. However, the feature value generated from the face image of the passenger as the biometric information may be transmitted to the server device 10. In this case, the server device 10 may execute the biometric authentication using the acquired feature value as it is.

In the above example embodiment, it is described that a passenger who performs a quarantine procedure is identified using biometric authentication. However, the passenger may be identified by terminal authentication. That is, when the registration of the passenger in the system is performed by the reception terminal 20, an ID number (for example, any ID such as an IP address, a terminal ID, or a terminal identification number) for identifying the terminal 50 possessed by the passenger instead of the biometric information about the passenger may be registered in the server device 10. The terminal 50 transmits the ID number instead of the biometric information about the passenger, the health information, and the result kit ID. The server device 10 stores these pieces of information in association with each other. When the passenger passes through the gate device 40, the gate device 40 acquires the ID number from terminal 50 to transmit an authentication request including the ID number to the server device 10. The server device 10 identifies the health information and the test result of the passenger from the ID number to transmit the authentication result to the gate device 40.

A form of data transmission and reception between the reception terminal 20 and the like and the server device 10 is not particularly limited, but data transmitted and received between these devices may be encrypted. The passport information includes personal information, and in order to appropriately protect the personal information, it is desirable that encrypted data be transmitted and received.

In the above example embodiment, the case where the test kit ID and the test result are transmitted from the quarantine terminal 30 to the server device 10, and the server device 10 identifies the passenger from the test kit ID is described. However, the identification of the passenger may be achieved by biometric authentication. For example, a face image of a passenger is affixed to a test kit to be delivered to the passenger. The quarantine terminal 30 transmits a test result registration request including the face image and the test result to the server device 10. The server device 10 may identify the passenger (entry) registered in the passenger database by the collation process using the face image included in the registration request.

In the flow chart (flowchart and sequence diagram) used in the above description, a plurality of steps (processes) is described in order, but the execution order of the steps executed in the example embodiment is not limited to the described order. In the example embodiment, for example, the order of the illustrated steps can be changed within a range in which there is no problem in terms of content, such as executing each step in parallel.

The above example embodiments have been described in detail in order to facilitate understanding of the present disclosure, and it is not intended that all the configurations described above are necessary. In a case where a plurality of example embodiments is described, each example embodiment may be used alone or in combination. For example, part of the configuration of the example embodiment can be replaced with the configuration of another example embodiment, or the configuration of another example embodiment can be added to the configuration of the example embodiment. Furthermore, it is possible to add, delete, and replace other configurations for part of the configuration of the example embodiment.

Although the industrial applicability of the present invention is apparent from the above description, the present invention is suitably applicable to a quarantine system in an airport or the like.

Some or all of the above example embodiments may be described as the following Supplementary Notes, but are not limited to the following.
[Supplementary Note 1]
   A server device including:
   an acquisition unit that acquires, of each of a plurality of users, biometric information and a test result of a test necessary for quarantine; and
   an authentication request processing unit that receives an authentication request including biometric information about an authenticatee from a gate device, identifies the authenticatee from among the plurality of users using biometric information about each of the plurality of users and biometric information about the authenticatee, and transmits an authentication result determined based on the test result of at least the identified authenticatee to the gate device.
[Supplementary Note 2]
   The server device according to Supplementary Note 1, further including a database that stores biometric information and a test result of each of the plurality of users.
[Supplementary Note 3]
   The server device according to Supplementary Note 2, wherein the authentication request processing unit executes a one-to-N collation process in which biometric information about the authenticatee is set on a collation side and biometric information about each of the plurality of users registered in the database is set on a registration side, where N is a positive integer, and identifies the authenticatee.
[Supplementary Note 4]
   The server device according to Supplementary Note 2 or 3, wherein
   the database stores a health condition of each of the plurality of users, and wherein
   the authentication request processing unit determines the authentication result based on a test result and a health condition of the identified authenticatee.
[Supplementary Note 5]
   The server device according to any one of Supplementary Notes 2 to 4, further including a test kit ID registration unit that
   receives a test kit ID registration request including a test kit ID given to a test kit for performing a test necessary for the quarantine and biometric information about a first user who uses the test kit,
   identifies the first user from among the plurality of users using biometric information about each of the plurality of users and biometric information about the first user, and
   registers the biometric information about the identified first user and the test kit ID included in the test kit ID registration request in association with each other in the database.
[Supplementary Note 6]
   The server device according to Supplementary Note 5, further including a test result registration unit that
   receives, from a quarantine terminal used by a quarantine officer, a test result registration request including the test kit ID given to the test kit for which a test necessary for the quarantine has ended and a test result of the test necessary for the quarantine, and
   searches the database using a test kit ID included in the test result registration request as a key, and registers the test result included in the test result registration request in an identified entry.
[Supplementary Note 7]
   The server device according to any one of Supplementary Notes 2 to 6, further including a health condition registration unit that
   receives a health condition registration request including information about health of a second user and the biometric information about the second user,
   determines a health condition of the second user based on the information about health,
   identifies the second user from among the plurality of users using biometric information about each of the plurality of users and biometric information about the second user, and
   registers the biometric information about the identified second user and the determined health condition in association with each other in the database.
[Supplementary Note 8]
   The server device according to Supplementary Note 7, wherein the information about health is an answer, to a question regarding health, by the second user.
[Supplementary Note 9]
   The server device according to any one of Supplementary Notes 2 to 8, further including a token issuance unit that
   receives a token issuance request including first biometric information about a seeker who wants to proceed with a quarantine procedure by biometric authentication and second biometric information described in an identification verification document of the seeker,
   issues a token ID for identifying the seeker in a case where identification of the seeker is successfully confirmed based on the first biometric information and the second biometric information, and
   registers the issued token ID and biometric information about the seeker in association with each other in the database.
[Supplementary Note 10]
   The server device according to Supplementary Note 9, wherein the token issuance unit determines that the identification is successfully confirmed when one-to-one collation using the first biometric information and the second biometric information is successful.
[Supplementary Note 11]
   The server device according to any one of Supplementary Notes 1 to 10, wherein the biometric information is a face image or a feature value generated from the face image.
[Supplementary Note 12]
   A system including
   a gate device that controls a gate, and
   a server device connected to the gate device, wherein
   the server device includes
   an acquisition unit that acquires, of each of a plurality of users, biometric information and a test result of a test necessary for quarantine, and
   an authentication request processing unit that receives an authentication request including biometric information about an authenticatee from the gate device, identifies the authenticatee from among the plurality of users using biometric information about each of the plurality of users and biometric information about the authenticatee, and transmits an authentication result determined based on the test result of at least the identified authenticatee to the gate device.
[Supplementary Note 13]
   A server device controlling method executed by a server device, the method including:
   acquiring, of each of a plurality of users, biometric information and a test result of a test necessary for quarantine;
   receiving an authentication request including biometric information about an authenticatee from a gate device;
   identifying the authenticatee from among the plurality of users using biometric information about each of the plurality of users and biometric information about the authenticatee; and transmitting an authentication result determined based on the test result of at least the identified authenticatee to the gate device.
[Supplementary Note 14]
   A non-transitory computer-readable storage medium storing a program for causing a computer mounted on a server device to execute the processing of:
   acquiring, of each of a plurality of users, biometric information and a test result of a test necessary for quarantine;
   receiving an authentication request including biometric information about an authenticatee from a gate device;
   identifying the authenticatee from among the plurality of users using biometric information about each of the plurality of users and biometric information about the authenticatee; and transmitting an authentication result determined based on the test result of at least the identified authenticatee to the gate device.

The disclosures of the cited prior art documents are incorporated herein by reference. While the exemplary example embodiments of the present invention have been described, the present invention is not limited to these example embodiments. It will be understood by those of ordinary skill in the art that these example embodiments are exemplary only and that various variations may be made therein without departing from the scope and spirit of the present invention as defined by the claims. That is, it goes without saying that the present invention includes various modifications and corrections that can be made by those of ordinary skill in the art in accordance with the entire disclosure including the claims and the technical idea.

### REFERENCE SIGNS LIST

10, 100 server device
20 reception terminal
30 quarantine terminal
40 to 42 gate device
50 terminal
101 acquisition unit
102, 606 authentication request processing unit
201, 301, 401, 501, 601 communication control unit
202 token issuance request unit
203 application providing unit
204, 304, 403, 504, 607 storage unit
302 health condition registration request unit
303 test kit ID registration request unit
311 processor
312 memory
313 input/output interface
314 communication interface
402 test result registration request unit
502 authentication request unit
503 gate control unit
602 token issuance unit
603 health condition registration unit
604 test kit ID registration unit
605 test result registration unit

What is claimed is:

1. A server device comprising:
at least one memory storing a set of instructions; and
at least one processor configured to execute the set of instructions to:
acquire, of each of a plurality of users, biometric information and a test result of a test necessary for quarantine;
receive an authentication request including biometric information about an authenticatee from a gate device;
identify the authenticatee from among the plurality of users using biometric information about each of the plurality of users and biometric information about the authenticatee; and
transmit an authentication result determined based on the test result of at least the identified authenticatee to the gate device.

2. The server device according to claim 1, further comprising a database that stores biometric information and a test result of each of the plurality of users.

3. The server device according to claim 2, wherein the at least one processor is further configured to execute the instructions to:
execute a one-to-N collation process in which biometric information about the authenticatee is set on a collation side and biometric information about each of the plurality of users registered in the database is set on a registration side, where N is a positive integer; and
identify the authenticatee.

4. The server device according to claim 2, wherein
the database stores a health condition of each of the plurality of users, and wherein
the at least one processor is further configured to execute the instructions to determine the authentication result based on a test result and a health condition of the identified authenticatee.

5. The server device according to claim 2, wherein the at least one processor is further configured to execute the instructions to:
receive a test kit ID registration request including a test kit ID given to a test kit for performing a test necessary for the quarantine and biometric information about a first user who uses the test kit;
identify the first user from among the plurality of users using biometric information about each of the plurality of users and biometric information about the first user; and
register the biometric information about the identified first user and the test kit ID included in the test kit ID registration request in association with each other in the database.

6. The server device according to claim 5, wherein the at least one processor is further configured to execute the instructions to:
receive, from a quarantine terminal used by a quarantine officer, a test result registration request including the test kit ID given to the test kit for which a test necessary for the quarantine has ended and a test result of the test necessary for the quarantine;
search the database using a test kit ID included in the test result registration request as a key; and
register the test result included in the test result registration request in an identified entry.

7. The server device according to claim 2, wherein the at least one processor is further configured to execute the instructions to:
receive a health condition registration request including information about health of a second user and the biometric information about the second user;
determine a health condition of the second user based on the information about health;
identify the second user from among the plurality of users using biometric information about each of the plurality of users and biometric information about the second user; and
register the biometric information about the identified second user and the determined health condition in association with each other in the database.

8. The server device according to claim 7, wherein the information about health is an answer, to a question regarding health, by the second user.

9. The server device according to claim 2, wherein the at least one processor is further configured to execute the instructions to:
receive a token issuance request including first biometric information about a seeker who wants to proceed with a quarantine procedure by biometric authentication and second biometric information described in an identification verification document of the seeker;
issue a token ID for identifying the seeker in a case where identification of the seeker is successfully confirmed based on the first biometric information and the second biometric information; and
register the issued token ID and biometric information about the seeker in association with each other in the database.

10. The server device according to claim 9, wherein the at least one processor is further configured to execute the instructions to determine that the identification is successfully confirmed when one-to-one collation using the first biometric information and the second biometric information is successful.

11. The server device according to claim 1, wherein the biometric information is a face image or a feature value generated from the face image.

12. A system including the server device according to claim 1, the system comprising
a gate device that controls a gate, wherein
the server device is connected to the gate device.

13. A server device controlling method executed by a server device, the method comprising:
acquiring, of each of a plurality of users, biometric information and a test result of a test necessary for quarantine;
receiving an authentication request including biometric information about an authenticatee from a gate device;
identifying the authenticatee from among the plurality of users using biometric information about each of the plurality of users and biometric information about the authenticatee; and
transmitting an authentication result determined based on the test result of at least the identified authenticatee to the gate device.

14. A non-transitory computer-readable storage medium storing a program for causing a computer mounted on a server device to execute the processing of:
acquiring, of each of a plurality of users, biometric information and a test result of a test necessary for quarantine;
receiving an authentication request including biometric information about an authenticatee from a gate device;
identifying the authenticatee from among the plurality of users using biometric information about each of the plurality of users and biometric information about the authenticatee; and
transmitting an authentication result determined based on the test result of at least the identified authenticatee to the gate device.
